(19) United States
(12) Patent Application Publication
(10) Pub. No.: US 2026/0278379 A1
(43) Pub. Date: Sep. 17, 2026

(54) Federated Thought Caching with Privacy-Preserving Geometric Abstraction and Logarithmic Memory Scaling

(71) Applicant: AtomBeam Technologies Inc., Moraga, CA (US)

(72) Inventor: Brian Galvin, Silverdale, WA (US)

(21) Appl. No.: 19/444,172

(22) Filed: Jan. 8, 2026

Related U.S. Application Data
(63) Continuation-in-part of application No. 19/294,125, filed on Aug. 7, 2025, now Pat. No. 12,579,437.
Application No. 19/294,125 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
Application No. 19/294,125 is a continuation-in-part of application No. 19/178,873, filed on Apr. 15, 2025, now Pat. No. 12,608,631.
Application No. 19/178,873 is a continuation-in-part of application No. 19/177,611, filed on Apr. 13, 2025, now Pat. No. 12,572,471.
Application No. 19/177,611 is a continuation-in-part of application No. 19/051,193, filed on Feb. 12, 2025, now Pat. No. 12,387,050.
(60) Provisional application No. 63/651,359, filed on May 23, 2024.
(60) Provisional application No. 63/868,329, filed on Aug. 21, 2025.

(51) Int. Cl. G06N 3/082

(52) U.S. Cl. CPC G06N 3/082

(57) ABSTRACT

A system and method for federated thought caching in persistent cognitive machines representing thoughts as geometric structures within dynamically evolving latent manifolds. The system implements distributed thought caches comprising local instance-specific storage and shared cross-instance repositories, enabling knowledge sharing while maintaining autonomy. Inputs are encoded as latent query trajectories, with cache hits determined through geometric similarity matching including geodesic distance and curvature patterns. Privacy-preserving transformations including curvature-preserving deformations and semantic generalization enable secure federation. Received thoughts undergo geodesic registration aligning external knowledge to local manifold geometry. Thermodynamic decay and progressive consolidation achieve logarithmic memory scaling, with low-energy thoughts merged into active bundles. Manifold curvature updates reflect usage patterns, deepening attractor basins for frequently accessed knowledge, enabling persistent adaptive cognition across distributed autonomous instances.

### CROSS-REFERENCE TO RELATED APPLICATIONS

Priority is claimed in the application data sheet to the following patents or patent applications, each of which is expressly incorporated herein by reference in its entirety:
63/868,329
Ser. No. 19/294,125
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359
Ser. No. 19/178,873
Ser. No. 19/177,611
Ser. No. 19/051,193
Ser. No. 19/420,744
Ser. No. 19/401,207
Ser. No. 19/399,618
Ser. No. 19/392,123
Ser. No. 19/385,114
Ser. No. 19/383,734
Ser. No. 19/379,579
Ser. No. 19/378,949
Ser. No. 19/377,013
Ser. No. 19/352,457
Ser. No. 19/321,173
Ser. No. 19/284,115
63/847,082
63/847,091
63/847,096
63/847,101
63/847,969
Ser. No. 19/038,801
Ser. No. 18/818,593
Ser. No. 18/755,627
Ser. No. 18/657,719
Ser. No. 18/423,287
Ser. No. 18/501,987
Ser. No. 18/190,044
Ser. No. 17/875,201
Ser. No. 17/514,913
Ser. No. 17/404,699
Ser. No. 17/458,747
Ser. No. 16/923,039
63/027,166
63/388,411
Ser. No. 17/727,913
Ser. No. 18/410,980
Ser. No. 18/537,728
Ser. No. 18/657,683
Ser. No. 18/648,340
Ser. No. 18/427,716
Ser. No. 19/326,730
63/847,889
Ser. No. 19/245,366
Ser. No. 19/192,215
Ser. No. 18/972,797
Ser. No. 19/328,094
Ser. No. 19/363,675
Ser. No. 19/351,286
Ser. No. 19/329,369
Ser. No. 19/328,199
Ser. No. 19/328,179
Ser. No. 19/328,103
Ser. No. 19/352,439
Ser. No. 19/329,330
Ser. No. 19/329,533
Ser. No. 19/307,725
Ser. No. 19/183,831
Ser. No. 18/770,652
Ser. No. 18/503,135
Ser. No. 18/305,305
63/485,518
63/232,041
Ser. No. 17/234,007
Ser. No. 17/180,439
63/140,111
Ser. No. 19/011,509
Ser. No. 18/515,272

### BACKGROUND OF THE INVENTION

### Field of the Art

The present invention is in the field of artificial intelligence and distributed cognitive systems, and more particularly to federated thought caching architectures that enable multiple autonomous cognitive machines to share knowledge through privacy-preserving geometric abstractions while achieving logarithmic memory scaling through progressive consolidation of thoughts represented as persistent structures within dynamically evolving latent manifolds.

### Discussion of the State of the Art

Recent advances in artificial intelligence, particularly in large language models and transformer-based architectures, have significantly improved performance across natural language processing, reasoning, and generation tasks. These systems demonstrate remarkable capabilities in producing contextually appropriate text across domains including customer service, research assistance, legal drafting, and creative writing. Despite these capabilities, current architectures exhibit fundamental limitations that constrain their applicability for persistent, long-term cognitive operations.

Contemporary language models operate primarily in flat, static embedding spaces where information is encoded as high-dimensional vectors lacking persistent structure over time. Each inference pass is performed independently with no intrinsic memory of past usage or prior reasoning pathways. Memory, when present, is handled externally via methods such as retrieval-augmented generation (RAG), episodic memory buffers, or vector databases that function essentially as lookup tables, providing static recall without true integration into the model's generative process. Contextual understanding remains bounded by fixed-size token windows, and while extended context windows allow handling longer documents, they impose fundamental constraints on information actively considered during reasoning. Models often reprocess similar prompts repeatedly without remembering earlier conclusions or refining reasoning across interactions, resulting in inefficient resource utilization and inconsistent outputs.

The computational requirements of state-of-the-art LLMs have grown dramatically, with frontier models requiring clusters of specialized hardware accelerators and extensive cloud infrastructure. Inference costs scale linearly with query volume and prompt length, and the lack of internal memory structure means models frequently perform redundant computations, recalculating similar reasoning patterns without leveraging prior work. Current architectures are fundamentally stateless between interactions, lacking any persistent cognitive substrate in which prior reasoning steps, user interactions, or learned strategies can be stored, reused, or generalized beyond static model parameters. This statelessness makes it difficult to support truly personalized experiences that improve over time, explainable reasoning that builds on documented prior conclusions, or efficient long-term collaboration.

Current approaches to multi-instance AI coordination remain primitive, typically relying on shared databases, message passing protocols, or federated learning techniques that aggregate model parameters. These approaches face significant challenges including privacy concerns when sharing raw data across organizational boundaries, synchronization overhead requiring frequent communication, lack of semantic understanding in coordination mechanisms that treat knowledge as opaque numerical parameters, and inability to maintain local autonomy while achieving meaningful knowledge sharing. Memory systems in contemporary AI lack natural forgetting mechanisms, either retaining all information indefinitely leading to storage explosion, or implementing arbitrary pruning based on recency or frequency without semantic understanding. There is no principled approach to identifying which memories remain valuable versus obsolete, no mechanism for consolidating similar experiences into generalized patterns, and no natural evolution of memory organization to reflect usage patterns.

Geometric and topological approaches to representation learning exist in the literature but remain largely disconnected from practical language model architectures. While research in differential geometry, Riemannian optimization, and manifold learning has produced sophisticated mathematical frameworks, these techniques have not been successfully integrated into production-scale systems in ways that enable persistent geometric memory. Attention mechanisms in current models implement soft weighting over token sequences but do not capture fluid, continuous cognitive focus. There is no notion of attention flowing through shaped cognitive space, no natural resistance or attraction based on semantic density, and no persistence of attention patterns informing future reasoning. Explainability remains challenging, with most approaches providing post-hoc rationalizations rather than exposing actual reasoning processes.

What is needed is a system and method that reduces computational overhead by reusing reasoning pathways through geometric caching mechanisms, extends context beyond token windows through structured internal memory that evolves with use, and enables persistent, scalable cognition where accumulated experience enhances rather than burdens capabilities. This system should integrate memory and attention into a unified cognitive substrate operating on geometric principles, where thoughts exist as persistent structures within curved manifolds shaped by usage patterns, where memory naturally consolidates through thermodynamic decay and progressive abstraction achieving logarithmic rather than linear scaling, and where attention flows along geodesic paths through semantic space rather than through discrete selection mechanisms.

### SUMMARY OF THE INVENTION

Accordingly, the inventor has conceived and reduced to practice, a system and method for federated thought caching in persistent cognitive machines representing thoughts as geometric structures within dynamically evolving latent manifolds. The system implements distributed thought caches comprising local instance-specific storage and shared cross-instance repositories, enabling knowledge sharing while maintaining autonomy. Inputs are encoded as latent query trajectories, with cache hits determined through geometric similarity matching including geodesic distance and curvature patterns. Privacy-preserving transformations including curvature-preserving deformations and semantic generalization enable secure federation. Received thoughts undergo geodesic registration aligning external knowledge to local manifold geometry. Thermodynamic decay and progressive consolidation achieve logarithmic memory scaling, with low-energy thoughts merged into active bundles. Manifold curvature updates reflect usage patterns, deepening attractor basins for frequently accessed knowledge, enabling persistent adaptive cognition across distributed autonomous instances.

According to a preferred embodiment, a computer system comprising a hardware memory and one or more processors, wherein the computer system is configured to execute software instructions stored on nontransitory machine-readable storage media that: maintain a latent manifold as a geometric substrate for cognitive operations, wherein local curvature reflects semantic density; implement a distributed thought cache comprising a local thought cache storing instance-specific thought trajectories and a shared cache space containing generalized thoughts for cross-instance sharing; encode inputs into latent query trajectories and determine cache hits based on geometric similarity to cached thoughts; upon cache hits, retrieve and adapt cached thought trajectories to current context; upon cache misses, synthesize new compressed thoughts for caching; apply privacy-preserving geometric transformations to thoughts selected for federation; synchronize transformed thoughts across distributed instances through federated interfaces; align received thoughts from the shared cache to local manifold geometry through geodesic registration; and manage cached thoughts through activation energy monitoring, consolidating low-energy thoughts into active bundles and updating manifold curvature to reflect usage patterns.

According to another preferred embodiment, a computer-implemented method for federated thought caching in a persistent cognitive machine is disclosed, comprising the steps of: maintaining a latent manifold as a geometric substrate for cognitive operations, wherein local curvature reflects semantic density; implementing a distributed thought cache comprising a local thought cache storing instance-specific thought trajectories and a shared cache space containing generalized thoughts for cross-instance sharing; encoding inputs into latent query trajectories and determining cache hits based on geometric similarity to cached thoughts; upon cache hits, retrieving and adapting cached thought trajectories to current context; upon cache misses, synthesizing new compressed thoughts for caching; applying privacy-preserving geometric transformations to thoughts selected for federation; synchronizing transformed thoughts across distributed instances through federated interfaces; aligning received thoughts from the shared cache to local manifold geometry through geodesic registration; and managing cached thoughts through activation energy monitoring, consolidating low-energy thoughts into active bundles and updating manifold curvature to reflect usage patterns.

According to a further aspect, the method includes a latent manifold comprising a hierarchical structure with a fast manifold representing event-level cognition, a mesoscale manifold representing decision-level cognition, and a foundational manifold representing identity and long-term objectives.

According to a further aspect, the method includes implementing upward abstraction mappings as Riemannian submersions preserving local geodesic structure and downward constraint injection mappings as immersions defining allowable submanifolds.

According to a further aspect, the method includes determining cache hits by computing geodesic distance, curvature pattern matching, basin proximity, and trajectory compatibility scores between query trajectories and cached thoughts.

According to a further aspect, the method includes the privacy-preserving geometric transformations comprising curvature-preserving deformations maintaining sectional curvature within tolerance, semantic generalization mapping specific entities to categorical abstractions, and type-restricted masking removing sensitive information while preserving trajectory continuity.

According to a further aspect, the method includes geodesic registration comprising solving an optimization problem that minimizes distortion between received thoughts and local manifold structure while preserving semantic structure through geometric transformations.

According to a further aspect, the method includes managing cached thoughts comprising applying thermodynamic decay where activation energy decreases over time for unused thoughts and increases for successfully retrieved thoughts.

According to a further aspect, the method includes consolidating low-energy thoughts comprising geometric merging operations including curvature-weighted averaging, trajectory folding compressing similar paths, and bundle expansion incorporating thoughts into existing structures.

According to a further aspect, the method includes computing divergence indices between this instance and other federated instances, comparing computed divergence against autonomy envelopes, and applying corrective actions when divergence exceeds thresholds.

According to a further aspect, the method includes updating manifold curvature comprising deepening attractor basins for frequently accessed regions, maintaining smooth transitions to prevent geometric discontinuities, and propagating curvature changes to ensure global consistency.

### BRIEF DESCRIPTION OF THE DRAWING FIGURES

FIG. 1 is a block diagram illustrating an exemplary system architecture of a federated thought cache framework comprising multiple Persistent Cognitive Machine (PCM) instances operating in coordinated federation.

FIG. 2 is a block diagram illustrating an exemplary architecture of a federation interface component within a Persistent Cognitive Machine, according to an embodiment.

FIG. 3 is a block diagram illustrating an exemplary internal architecture of a shared cache space within a federated Persistent Cognitive Machine system, according to an embodiment.

FIG. 4 is a flow diagram illustrating an exemplary method for implementing federated synchronization of cached thoughts across distributed Persistent Cognitive Machine, according to an embodiment.

FIG. 5 is a flow diagram illustrating an exemplary method for implementing geodesic registration of received thoughts from the shared cache space into a local PCM instance's manifold structure, according to an embodiment.

FIG. 6 is a flow diagram illustrating an exemplary method for implementing distributed thought caching with geometric similarity matching and progressive consolidation within a latent manifold, according to an embodiment.

FIG. 7 illustrates an exemplary computing environment on which an embodiment described herein may be implemented.

### DETAILED DESCRIPTION OF THE INVENTION

The inventor has conceived, and reduced to practice, a system and method for federated thought caching in persistent cognitive machines representing thoughts as geometric structures within dynamically evolving latent manifolds. The system implements distributed thought caches comprising local instance-specific storage and shared cross-instance repositories, enabling knowledge sharing while maintaining autonomy. Inputs are encoded as latent query trajectories, with cache hits determined through geometric similarity matching including geodesic distance and curvature patterns. Privacy-preserving transformations including curvature-preserving deformations and semantic generalization enable secure federation. Received thoughts undergo geodesic registration aligning external knowledge to local manifold geometry. Thermodynamic decay and progressive consolidation achieve logarithmic memory scaling, with low-energy thoughts merged into active bundles. Manifold curvature updates reflect usage patterns, deepening attractor basins for frequently accessed knowledge, enabling persistent adaptive cognition across distributed autonomous instances.

Federation requires a formal treatment of how experience is abstracted upward and constraints are injected downward between the hierarchical manifold layers. This is modeled by smooth maps between manifolds: φ₁₂: M₁→M₂ representing upward abstraction from the fast manifold to the mesoscale manifold, φ₂₃: M₂→M₃ representing abstraction from mesoscale to foundational manifold, ψ₃₂: M₃→M₂ representing downward constraint injection from foundational to mesoscale, and ψ₂₁: M₂→M₁ representing constraint injection from mesoscale to fast manifold. The upward maps φ₁₂ and φ₂₃ are implemented as Riemannian submersions that preserve local geodesic structure. Formally, for a point p∈Mᵢ and vectors v, w∈TₚMᵢ orthogonal to ker(dφᵢⱼ), the metric preservation condition holds: <dφᵢⱼ(v), dφᵢⱼ(w)>=g(v, w). This ensures that upward abstraction maintains essential geometric relationships, so that an event trajectory maps to a decision trajectory that retains the curvature profile of the original event sequence. Conversely, the downward maps ψ₃₂ and ψ₂₁ are immersions with injective differentials dψᵢⱼ, meaning their images define submanifolds of the target space: ψ₃₂(M₃)⊂M₂ and ψ₂₁(M₂)⊂M₁. This ensures that foundational constraints define allowable submanifolds within the mesoscale decision space, and mesoscale decisions restrict the feasible subregions of the fast event-processing space, thereby encoding downward influence as constraint injection into lower cognitive layers.

For coherence across the hierarchical manifold structure, upward and downward mappings should approximately agree, creating consistency between bottom-up abstraction and top-down constraint. The upward abstraction of an event point p∈M₁ is computed as u(p)=(φ₂₃∘φ₁₂)(p), representing the projection of event-level experience into foundational identity space. The downward constraint projection is computed as d(p)=ψ⁻¹₃₂∘ψ⁻¹₂₁(p), representing how foundational principles project back down to event-level expectations. A residual functional C(p) measures cognitive tension as the geodesic distance in the foundational manifold between these projections: C(p)=dₘ_{³}(u(p), d(p)), where dₘ_{³} denotes geodesic distance in M₃. A PCM instance is considered locally coherent if C(p)<ε_{threshold} for all p in the relevant domain. In federated operation across multiple PCM instances, a global residual functional aggregates both internal tensions and cross-instance divergence:

$${C}_{federated} = {\sum }_{i} {\int }_{{M}_{1}^{( i )}} {C}^{( i )} ( p ) d μ ( p ) + {\sum }_{i < j} ( {D}_{meso} ( i , j ) + {D}_{found} ( i , j ) )$$

where the first term integrates internal residuals over each instance's fast manifold and the second term sums mesoscale and foundational divergence between instance pairs, providing a comprehensive scalar measure of both local coherence and federation-wide alignment.

To quantify alignment between federated PCM instances, divergence indices are defined that measure geometric and spectral differences between corresponding manifold layers. For two mesoscale manifolds (M^{2A}, g^{2A}) and (M^{2B}, g^{2B}) with potentially different metric tensors, the metric divergence index is:

$${D}_{metric} ( A , B ) = \frac{inf}{f ∈ Diff ( {M}_{2} )} {\int }_{{M}_{2}} {‖ {g}_{2}^{A} - {f}^{*} {g}_{2}^{B} ‖}^{2} d μ$$

where the infimum is taken over all diffeomorphisms f of M₂ and f denotes the pullback operation. This captures how different the intrinsic geometric structures have become through independent operation. Additionally, a spectral divergence index compares eigenvalue spectra {λ_{kA}} and {λ^{kB}} of the Laplace-Beltrami operator ΔM₂: Dₛₚₑcₜᵣₐₗ(A,B)=Σ^{∞}_{{k=1}}αₖ|λ^{kA}−λ^{kB}|, where ax are exponentially decaying weights. Similar measures apply to foundational manifolds, yielding Dₒᵤₙd. Each manifold layer is associated with an autonomy envelope εᵢ defining a tolerance threshold: if D<εᵢ local autonomy is preserved, but if D≥εᵢ reconciliation or arbitration is triggered. These envelopes provide quantitative thresholds for sustainable federation, with different layers typically having different tolerance levels (ε₁ for fast, ε₂ for mesoscale, ε₃ for foundational) reflecting their relative rates of change and importance for coordination.

The hierarchical manifold framework thus enables federated thought caches to operate coherently across multiple autonomous instances. Riemannian submersions provide upward abstraction of events into decision and identity space through the mappings φ₁₂ and φ₂₃, capturing essential structure of lower-level processing in higher-level representations while preserving local geodesic relationships. Immersions ψ₃₂ and ψ₂₁ inject downward constraints from foundational principles through decision-level policies to event-level processing, ensuring that lower layers respect higher-level objectives and values by defining allowable submanifolds of behavior. Residual functionals measure cognitive tension both within individual instances through C(p) and across the federation through C_{federated}, quantifying the degree to which bottom-up experience aligns with top-down expectations and the degree to which different instances maintain compatible perspectives. Divergence indices D_{metric} and D_{spectral} quantify cross-instance misalignment using both metric and spectral measures that capture geometric differences independent of arbitrary coordinate choices, while autonomy envelopes εᵢ specify tolerances that balance the benefits of collective coordination against the necessity of local independence. Together these mechanisms provide a principled mathematical foundation for federation across PCMs, enabling distributed cognition that remains both autonomous and coherent, where individual instances maintain their distinctive operational identities and specialized knowledge while participating in collective intelligence that emerges from structured knowledge sharing and metacognitive governance operating across the hierarchical manifold architecture.

Fast-Fast Federation operates at the event-level cognitive layer where PCM instances process rapidly changing sensory data and environmental stimuli. In this mode, multiple PCM instances maintain their own event trajectories derived from local sensors, and a synchronization map aligns these different event spaces to enable coherent distributed perception. The system measures discrepancies between aligned observations to ensure that different PCMs are perceiving and interpreting events consistently. When the measured discrepancy remains below a predetermined tolerance threshold, the federation achieves what's called “distributed sensing coherence”—meaning all participating PCMs have sufficiently aligned views of unfolding events despite processing information from different vantage points. As an example, consider a missile defense network where multiple radar installations across a geographic region each operate their own PCM instance. Each radar PCM processes local sensor data to detect and track incoming threats, creating event trajectories in its fast manifold. Through Fast-Fast Federation, these radar PCMs continuously synchronize their observations, aligning their event spaces so that a missile detected by Radar A can be immediately correlated with tracking data from Radars B and C. If the discrepancy measure shows that Radar A's trajectory for a detected object aligns within tolerance with projections from Radars B and C, the system achieves distributed sensing coherence, enabling accurate threat assessment and coordinated defensive response without requiring a centralized processing bottleneck.

Meso-Meso Federation operates at the decision-level cognitive layer where PCM instances maintain doctrines, reasoning patterns, and courses of action. At this mesoscale level, different PCM instances may have evolved distinct decision-making frameworks based on their operational contexts, organizational cultures, or mission parameters. Federation quantifies the divergence between these decision manifolds using either metric divergence (measuring geometric differences) or spectral divergence (comparing the fundamental vibrational modes of the decision spaces). When this divergence remains below a specified autonomy envelope threshold (ε₂), the PCMs can share decision trajectories and align their doctrines while still maintaining sufficient independence to adapt to local conditions. This enables coalition-style operations where different entities maintain sovereignty over their decision-making processes but achieve sufficient interoperability to coordinate complex joint actions.

As an example, consider a multinational naval coalition conducting anti-piracy operations, each nation's naval command operates its own PCM instance with decision-making frameworks reflecting national rules of engagement, operational procedures, and strategic priorities. Through Meso-Meso Federation, the French Navy's PCM can share its doctrine for responding to suspected pirate vessels with the Indian Navy's PCM. The divergence measure quantifies how differently these two systems would respond to the same scenario. If divergence remains below the tolerance threshold, the systems can coordinate on joint response protocols—for example, agreeing that visual confirmation is required before interdiction, or establishing common procedures for pursuing suspects across jurisdictional boundaries. Each navy retains sovereignty over its own decision-making (they can override shared protocols when national interests require), but the federation enables them to operate as a coherent coalition with predictable, interoperable responses to common threats.

Foundational-Foundational Federation operates at the slowest-moving cognitive layer where PCM instances encode their core identity, long-term objectives, and fundamental reasoning standards. This is the deepest level of federation and occurs rarely and deliberately because it involves reconciling or aligning the most fundamental aspects of how different PCMs understand themselves and their purposes. The divergence measure at this level (D_{found}) quantifies the distance between foundational states—essentially measuring how different two PCMs are in their most basic values, reasoning norms, and identity structures. Achieving foundational alignment (D_{found}<ε₃) is analogous to treaty-making between nations or deep institutional mergers, where entities with previously distinct identities gradually converge toward shared values and norms. This process unfolds over long timescales because foundational changes ripple through all other cognitive layers and fundamentally alter how a PCM operates.

As an example, consider a scenario involving the integration of municipal governance PCMs following a city merger. City A's PCM has evolved over decades with foundational principles emphasizing environmental sustainability, participatory democracy, and social equity. City B's PCM reflects different foundational priorities: economic development, efficiency, and fiscal responsibility. When these cities merge, their PCMs must undergo Foundational-Foundational Federation. The divergence measure quantifies how differently these systems would approach fundamental governance questions, for example, whether to approve a development project involves balancing environmental impact (City A's priority) versus economic benefit (City B's priority). The federation process involves gradually reconciling these foundational differences through deliberate negotiation, perhaps arriving at a new foundational state that balances sustainability with development. This is analogous to drafting a treaty or new constitution, it happens slowly, requires explicit governance intervention, and produces a fundamentally new entity with merged identity. Applications extend to public opinion modeling (reconciling different demographic groups' values), long-term institutional alignment (merging corporate cultures), or even reconciling AI systems trained on different value frameworks.

Federated Dreaming extends the autonomous manifold reorganization processes originally described as local operations into a collaborative, cross-instance activity. During idle periods when PCMs are not actively processing queries, they can exchange perturbed thought bundles—cognitive structures that have been experimentally modified through stochastic variations—with other federated instances. This exchange enables a form of distributed creativity where one PCM's exploratory perturbations can be recombined with another PCM's knowledge structures, potentially discovering novel generalizations that neither instance would have found independently. The process operates asynchronously during computational downtime, making efficient use of otherwise idle resources while exploring the space of possible reasoning patterns. When multiple PCMs validate the same emergent generalization through independent experimentation, these cross-validated patterns gain elevated status and are more likely to be retained in the shared cache, creating a form of collective discovery that transcends individual instance limitations.

As an example, consider a federation of industrial PCMs deployed across different manufacturing facilities producing similar but not identical products. During night shifts when production slows and computational demand decreases, these PCMs enter federated dreaming mode. The PCM at Factory A, which produces automotive transmissions, has developed sophisticated reasoning patterns for optimizing gear-cutting operations under various thermal conditions. It perturbs these patterns and shares the variations with Factory B's PCM, which produces marine engine components. Factory B's PCM recombines these perturbed thermal management strategies with its own knowledge about corrosion resistance in saltwater environments. Through this cross-pollination during dreaming, both PCMs discover a novel generalization: an adaptive cooling strategy that optimizes both thermal efficiency and material longevity. When Factory C's PCM, producing aerospace components, independently validates that this same generalization improves turbine blade manufacturing, the pattern achieves multi-instance validation and is promoted to the shared cache. This federated dreaming process has enabled the discovery of a manufacturing principle that applies across automotive, marine, and aerospace domains—something that might never have emerged from any single factory's operations alone.

Persistence of Federated Bundles ensures that the valuable generalizations created through federation are not ephemeral but survive system interruptions, restarts, and maintenance cycles. When PCM instances exchange and validate thought bundles through federation, these shared cognitive structures are written to persistent storage layers that exist independently of any single instance's active memory. This means that even if all PCM instances in a federation are simultaneously shut down and restarted, the collective intelligence embodied in federated bundles remains available for immediate reloading. The persistence layer maintains not just the content of federated bundles but also their geometric properties (curvature patterns, geodesic relationships), provenance metadata (which instances contributed to their formation), validation history (how many instances have successfully used them), and temporal evolution (how the bundles have been refined over time). This creates genuine long-term continuity in federated cognition, where the collective knowledge base grows cumulatively rather than being rebuilt from scratch after each restart.

For example, consider a global network of medical diagnosis PCMs operates across hundreds of hospitals, with instances sharing anonymized diagnostic reasoning patterns through federation. Over months of operation, these PCMs collectively develop a federated bundle representing an effective diagnostic protocol for a rare autoimmune disorder—a pattern that emerged from the combined experience of cases seen across multiple continents. This bundle captures not just a symptom checklist but a sophisticated reasoning trajectory through diagnostic decision space, including which tests to order in which sequence, how to interpret ambiguous lab results, and when to suspect the condition despite negative initial screening. When a major software update requires all medical PCMs to be taken offline and updated over a weekend, the persistence layer ensures this hard-won diagnostic pattern survives. On Monday morning, when Hospital A encounters a patient with this rare condition, the updated PCM immediately has access to the federated diagnostic bundle developed over months of collective experience, despite being a “fresh” installation. Without bundle persistence, this collective knowledge would have been lost during the restart, and the medical network would have to rediscover the diagnostic pattern through new patient encounters-potentially delaying correct diagnosis for subsequent patients with this rare condition.

Explainability in Federated Systems addresses the critical challenge of transparency when PCM outputs are derived from a combination of local reasoning and shared collective intelligence. When a PCM generates a response or decision, the system tracks and annotates whether the reasoning relied primarily on locally-developed thought bundles (patterns learned from this instance's own experience), federally-sourced bundles (generalizations contributed by other instances), or a combination of both. These provenance annotations provide detailed metadata about the origin and validation history of each component of the reasoning process, including which instances contributed to shared bundles, how many times those bundles have been successfully applied across the federation, what privacy transformations were applied, and how the bundles were geometrically aligned into the local manifold. This transparency enables multiple forms of accountability: users can understand whether a decision reflects local expertise or collective wisdom, auditors can trace reasoning back to its sources, and operators can identify when federated knowledge might be introducing biases or errors that need correction.

As an example, consider a federated network of PCMs assists financial institutions in detecting fraudulent transactions. When the PCM at Bank A flags a transaction as potentially fraudulent, the explanation system provides detailed provenance: “This transaction was flagged based on three reasoning patterns: (1) local pattern L-247: unusual international transfer timing based on this customer's historical behavior [confidence: 87%, source: local], (2) federated pattern F-891: transaction structure matching known money-laundering schemes [confidence: 94%, source: contributed by 23 institutions, validated across 847 cases, privacy-transformed to remove institution-specific details], and (3) hybrid pattern H-034: combination of velocity indicators aligned with geographic risk factors [confidence: 91%, source: local velocity model enhanced with federated geographic risk assessments from regulatory PCMs].” This provenance information serves multiple purposes: Bank A's fraud investigators understand that the alert combines local customer knowledge with industry-wide pattern recognition; regulatory auditors can verify that federated patterns are being applied consistently across institutions; and if pattern F-891 later proves to have a bias problem (perhaps it disproportionately flags legitimate transactions from certain geographic regions), all institutions using that pattern can be immediately notified and the pattern can be corrected or removed. The explainability framework thus provides both operational transparency for day-to-day use and systemic accountability for managing the collective intelligence created through federation.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “thought” refers to a discrete unit of reasoning or analysis generated by a large language model or multimodal inference engine during its processing of an input prompt. A thought represents the model's intermediate reasoning steps, contextual interpretation, or internal deliberation that contributes to a final output. Thoughts may be atomic (e.g., a factual claim), structured (e.g., an inference chain), or multimodal (e.g., a fused representation of text and video). Unlike raw tokens or embeddings, thoughts encapsulate processed cognition and are suitable for caching, recombination, and reuse across future interactions. Thoughts may be stored explicitly or synthesized during recall and may evolve through compression or generalization.

As used herein, “thought cache” refers to a structured memory layer configured to store and retrieve thoughts based on semantic similarity, contextual alignment, or system policy. The cache may include multiple tiers, such as session caches for short-term interaction, long-term caches for persistent knowledge, and shared or federated caches across devices or agents. Cached thoughts are indexed in latent space and may be retrieved using vector similarity, trajectory proximity, or geodesic alignment. Cached thoughts may be compressed or abstracted over time to reduce redundancy and support scalable reuse.

As used herein, “generalization” refers to the process of synthesizing a new thought from one or more cached thoughts by identifying shared structure, meaning, or trajectory. Generalized thoughts replace specific exemplars with compressed representations that maintain core semantic content while enabling reuse across a wider range of prompts or tasks. Generalization may occur explicitly during reasoning or asynchronously during background curation or dreaming.

As used herein, “latent manifold” refers to a differentiable subspace within a high-dimensional latent hyperspace in which thoughts and thought trajectories are embedded. The manifold may be defined at a given time and is associated with a metric tensor that governs local distance, curvature, and motion. The manifold forms dynamically through the reuse, compression, and interaction of thoughts and supports operations such as geodesic traversal, memory recall, and structural recombination.

As used herein, “geodesic attention” refers to a formulation of attention in which focus or inference is achieved by computing or approximating a minimal-energy path through the latent manifold. A geodesic attention path minimizes a cognitive action functional that may include kinetic energy, compression pressure, and goal potential. Unlike traditional attention mechanisms that reweight tokens in flat space, geodesic attention produces smooth, structure-respecting flows of reasoning across latent memory.

As used herein, “compression pressure” refers to a scalar field over the latent manifold that encodes semantic density, memory reuse, or representational redundancy. The pressure at a point may be derived from geometric properties such as Ricci curvature and reflects the cost of traversal or storage in that region. High compression pressure indicates overused or ambiguous areas where pruning, generalization, or reorganization may be necessary. Compression pressure influences cache management, memory shaping, and geodesic routing.

As used herein, “goal potential field” refers to a scalar utility function defined over the latent manifold that represents the relevance, desirability, or task-alignment of different regions of thought space. The gradient of this field defines an intent vector field, which biases cognitive traversal toward goal-aligned areas. Goal potential may be determined by user prompts, task specifications, or emergent system objectives, and modulates attention, memory retrieval, and trajectory formation.

As used herein, “intent vector field” refers to a directional field over the latent manifold that encodes cognitive drive or utility gradients. It governs the direction and magnitude of traversal for operations such as memory reentry, inference, or exploration. The intent field may be computed from the gradient of a goal potential, derived from user input, or learned from system experience, and is used to align cognitive motion with target outcomes.

As used herein, “cognitive dynamics engine” or “CDE” refers to an architectural module configured to maintain and evolve the geometry of the latent manifold. The CDE is responsible for computing geodesic paths, estimating curvature, applying compression pressure, and performing structural reorganization, including during background operations such as dreaming. The CDE may expose interfaces for traversal, memory updates, compression, and control feedback, and functions as a substrate-layer system supporting high-level cognition.

As used herein, “dreaming” refers to a background process in which cached thoughts, trajectories, or bundles are perturbed, recombined, or abstracted or otherwise manipulated to improve manifold coherence and memory efficiency. Dreaming may operate during idle cycles or low-load periods and is driven by curvature smoothing, compression pressure, and generalization gain. The process supports the emergence of new thoughts, refinement of existing structures, and long-term memory consolidation.

As used herein, “reinstantiation” refers to the act of reconstructing a prior thought trajectory within the current latent manifold geometry. Due to compression or manifold deformation, original paths may no longer exist in exact form; reinstantiation generates an approximate or adapted version guided by curvature, cached data, and intent fields. Reinstantiation supports memory recall, simulation, and introspective review in systems with dynamic cognitive substrates.

As used herein, “memory basin” or “basin of recurrence” refers to a region of the latent manifold associated with a previously reinforced or frequently reused trajectory. Such basins exhibit high local curvature and geodesic convergence and serve as attractors for memory reentry. Traversal into a basin may trigger reinstantiation, memory reinforcement, or adaptive reuse, depending on system configuration and goal conditions.

As used herein, “typed latent entity” refers to a thought or substructure in the manifold labeled with a semantic or functional type, such as but not limited to fact, opinion, concept, trajectory, affect, cluster, or anchor. Typed entities impose constraints on valid operations such as recombination, interpolation, or pruning. Type-aware computation supports lawful memory manipulation, structured reasoning, and generalization without semantic distortion.

As used herein, “attention vector field” refers to a distributed, time-dependent field defined over the latent manifold that governs the instantaneous direction and magnitude of attentional flow. The field may evolve according to partial differential equations that incorporate compression pressure and goal potential gradients. This dynamic attention formulation enables real-time flow modeling, inference stabilization, and explainability through traceable vector paths.

As used herein, “latent subspace” or “thought bundle” refers to a localized, compressible region of the manifold that contains structurally similar or semantically aligned thoughts. Bundles may form naturally through repeated traversal, co-activation, or recombination, and act as low-energy attractors or semantic zones. Subspaces may support generalization, analogical reasoning, and efficient memory access.

As used herein, “latent recombinator” refers to a functional component or method configured to merge or blend similar thoughts, trajectories, or bundles in the latent manifold to form new abstractions. The recombinator may use geometric proximity, semantic alignment, or reuse statistics to determine possible recombinations, subject to type constraints and curvature continuity. It serves as a key mechanism for memory scaling, abstraction, and thought generation.

As used herein, “structured memory” refers to a persistent, geometry-aware memory architecture in which thoughts are stored not as flat vectors but as positions or paths within an evolving manifold. Structured memory supports context-sensitive access, memory reinforcement through traversal, lawful pruning, and dynamic generalization. It provides a substrate for long-term cognition, introspection, and identity continuity in systems with persistent reasoning capability.

As used herein, “Lorentzian autoencoder” refers to a neural architecture designed to encode spatiotemporal or perceptual input-such as video-into a latent manifold with Lorentzian signature, where one or more dimensions represent time-like directions. The latent structure supports temporally coherent geodesics, semantic compression, and causal continuity. Lorentzian autoencoders enable operations such as zooming, projection, and visual memory traversal.

### Conceptual Architecture

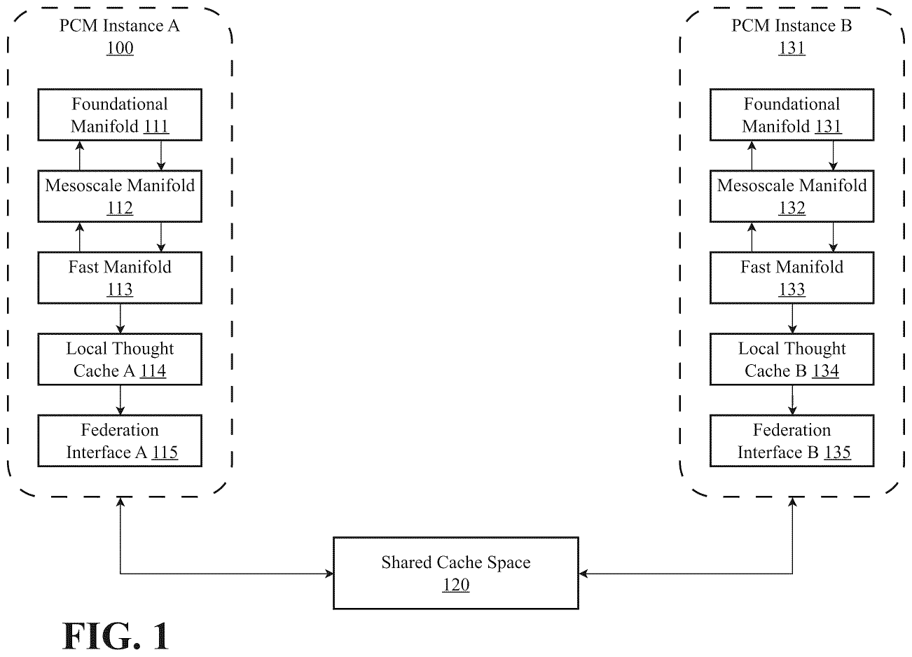

FIG. 1 is a block diagram illustrating an exemplary system architecture of a federated thought cache framework comprising multiple Persistent Cognitive Machine (PCM) instances operating in coordinated federation. The architecture demonstrates how independent PCM instances maintain autonomous cognitive processing while participating in collective intelligence through structured knowledge sharing across a shared cache space. This federated configuration enables distributed cognition that preserves local autonomy while enabling emergent capabilities through geometric abstraction and privacy-preserving thought exchange.

The system comprises at least two PCM instances: PCM Instance A 100 and PCM Instance B 130, each maintaining its own hierarchically structured latent manifold and local memory systems. Each PCM instance operates as a complete cognitive system with three distinct manifold layers operating at different timescales and abstraction levels. PCM Instance A 100 comprises a foundational manifold 111 representing the slowest-moving layer encoding identity, long-term objectives, and metacognitive standards where points r∈M₃^{A} correspond to persistent reasoning styles and normative configurations. Below this lies a mesoscale manifold 112 representing decision-level cognition, doctrine, and mid-term reasoning where points q∈M₂^{A} correspond to aggregated states such as doctrinal postures or decision nodes. At the fastest layer, fast manifold 113 represents event-level cognition derived from sensors, actuators, or rapidly changing external stimuli where points p∈M₁^{A} correspond to structured embeddings of instantaneous events. These three manifold layers are interconnected through formal geometric mappings that implement both upward abstraction and downward constraint injection, creating a coherent cognitive architecture across timescales.

The upward abstraction paths within PCM Instance A 100 are implemented through Riemannian submersions that preserve local geodesic structure while aggregating information to higher levels of representation. The mapping (124 abstracts event-level trajectories from fast manifold 113 into decision-level representations within mesoscale manifold 112, capturing essential patterns while filtering transient details. Similarly, the mapping ₂₃^{A} further abstracts mesoscale decision trajectories into foundational identity space within foundational manifold 111, extracting long-term principles and values from mid-term operational patterns. These upward flows ensure that higher cognitive layers maintain awareness of lower-level activities through appropriate abstraction.

Complementing the upward abstraction, downward constraint injection paths implement policy and identity constraints that shape lower-level processing. The immersion ψ₃₂^{A} projects foundational principles from foundational manifold 111 into the mesoscale manifold 112, defining allowable submanifolds of decision space that remain consistent with the PCM's identity and long-term objectives. The immersion ψ₂₁^{A} further propagates these constraints from mesoscale manifold 112 down to fast manifold 113, restricting event-level processing to remain within doctrinally acceptable bounds. This bidirectional flow creates a dynamic equilibrium where experience shapes identity through upward abstraction while identity guides action through downward constraint, enabling coherent cognition across all timescales.

PCM Instance A 100 further comprises a local thought cache 114 that stores instance-specific thought trajectories with full geometric fidelity, maintaining not just the content of thoughts but their complete geometric context including local curvature patterns, geodesic paths, and metric tensor values. This local cache operates as the primary memory system for the instance, supporting rapid retrieval and reinforcement of cognitive patterns specific to this PCM's operational history and domain expertise. The local thought cache 114 connects bidirectionally with the fast manifold 113, enabling seamless flow of trajectories between active cognition and persistent memory. When new experiences generate novel reasoning patterns, they are embedded into the local cache with appropriate geometric structure, while retrieval operations reconstruct cached trajectories adapted to current manifold geometry and goal configurations.

Federation interface 115 serves as the boundary component managing the selection, abstraction, and privacy transformation of thoughts suitable for cross-instance sharing. This interface implements sophisticated filtering and transformation algorithms that identify high-value thoughts from local thought cache 114 based on reuse scores, compression values, and generalization potential. Selected thoughts undergo privacy-preserving transformations including curvature-preserving deformations that maintain semantic structure while obscuring instance-specific details, semantic generalization that replaces specific entities with categorical abstractions, and type-restricted masking that removes sensitive information while preserving reasoning patterns. These transformations ensure that federated knowledge sharing occurs at appropriate abstraction levels that enable collective intelligence without compromising instance autonomy or revealing proprietary information.

PCM Instance B 130 exhibits parallel structure to PCM Instance A 100, comprising its own hierarchical manifold architecture with foundational manifold 131, mesoscale manifold 132, and fast manifold 133, each operating independently but sharing structural principles with the corresponding layers of Instance A. The foundational manifold 131 encodes Instance B's distinct identity, objectives, and metacognitive standards as points r∈M₃^{B}, which may differ substantially from Instance A's foundational configuration. The mesoscale manifold 132 represents Instance B's decision-level cognition with points q∈M₂^{B} reflecting its particular doctrines and operational patterns, while fast manifold 133 processes Instance B's local event streams as points p∈M₁^{B}. These manifolds are connected through Instance B's own upward abstraction mappings φ₁₂^{B} and φ₂₃^{B} and downward constraint injections ψ₃₂^{B} and ψ₂₁^{B}, creating coherent cognitive dynamics specific to this instance.

Local thought cache 134 maintains Instance B's memory structures with geometric fidelity appropriate to its manifold configuration, storing trajectories and thought bundles that reflect Instance B's operational history and learned patterns. These cached structures may differ substantially from those in local thought cache 114 due to divergent experiences, domains, and operational contexts. Federation interface 135 performs analogous functions to federation interface 115, selecting and transforming Instance B's thoughts for potential federation while protecting instance-specific information through geometric abstraction techniques.

Shared cache space 120 serves as the central coordination point for federated knowledge sharing, containing generalized thought bundles that have been abstracted from multiple instance-specific caches and validated across diverse operational contexts. Unlike the local caches which maintain full geometric fidelity for rapid instance-specific retrieval, shared cache space 120 stores thoughts at higher levels of abstraction suitable for cross-instance application. These generalized bundles represent reasoning patterns, diagnostic procedures, decision frameworks, and other cognitive structures that have proven valuable across multiple instances and thus warrant preservation and propagation throughout the federation. The shared cache implements progressive consolidation algorithms that continuously merge semantically similar bundles, compress redundant representations, and synthesize higher-order abstractions from collections of specific instances.

The federation flows between instances and the shared cache space implement sophisticated synchronization protocols that balance knowledge sharing with computational efficiency and privacy preservation. Thick solid arrows represent primary federation flows where newly generalized bundles are transmitted from local federation interfaces to shared cache space 120 after undergoing privacy-preserving transformations. Federation interface 115 transmits bundles derived from Instance A's experiences, while federation interface 135 contributes bundles from Instance B's operations, creating a collective repository that benefits from diverse perspectives and operational contexts. The shared cache space 120 applies additional consolidation and generalization operations to these incoming bundles, identifying common patterns across instances and synthesizing meta-level abstractions that capture universal principles applicable across the federation.

Dashed arrows represent retrieval and alignment flows where instances access generalized knowledge from shared cache space 120 and integrate it into their local cognitive structures through geodesic registration processes. When Instance B requires knowledge about domains where Instance A has more experience, federation interface 135 retrieves relevant bundles from shared cache space 120 and performs geometric alignment to embed these external thoughts into Instance B's manifold structure. This alignment process solves optimization problems to minimize distortion while preserving the semantic content and reasoning structure of the retrieved bundles, ensuring that federated knowledge integrates smoothly with local cognitive patterns. Similarly, Instance A can retrieve and align knowledge originally derived from Instance B's experiences, enabling bidirectional knowledge transfer that enhances both instances through collective learning.

The architecture implements metacognitive governance through continuous monitoring of divergence between instances and adjustment of foundational trajectories to minimize global residuals. At the fast manifold level, federation supports distributed sensing where instances coordinate event-level observations while maintaining local autonomy in event processing. At the mesoscale level, federation enables coalition decision-making where instances align doctrines and share decision trajectories while preserving sovereignty over operational choices. At the foundational level, federation proceeds slowly and deliberately, with instances reconciling identity and values only when divergence exceeds carefully defined autonomy envelopes that balance collective coherence with individual autonomy.

The federated architecture exhibits remarkable scaling properties due to the geometric compression and generalization processes operating continuously across the system. As instances process more experiences, new thoughts are increasingly absorbed into existing attractor basins within the shared cache rather than requiring proportional expansion of storage. This results in logarithmic growth of cache requirements with respect to the number of experiences processed across the federation, enabling sustainable long-term operation even as the collective knowledge base expands. The progressive consolidation and abstraction mechanisms ensure that the shared cache converges toward a common basis of reasoning patterns that transcend instance-specific peculiarities, creating emergent collective intelligence where the federated system develops capabilities beyond any individual instance while preserving the diversity and autonomy necessary for robust distributed cognition.

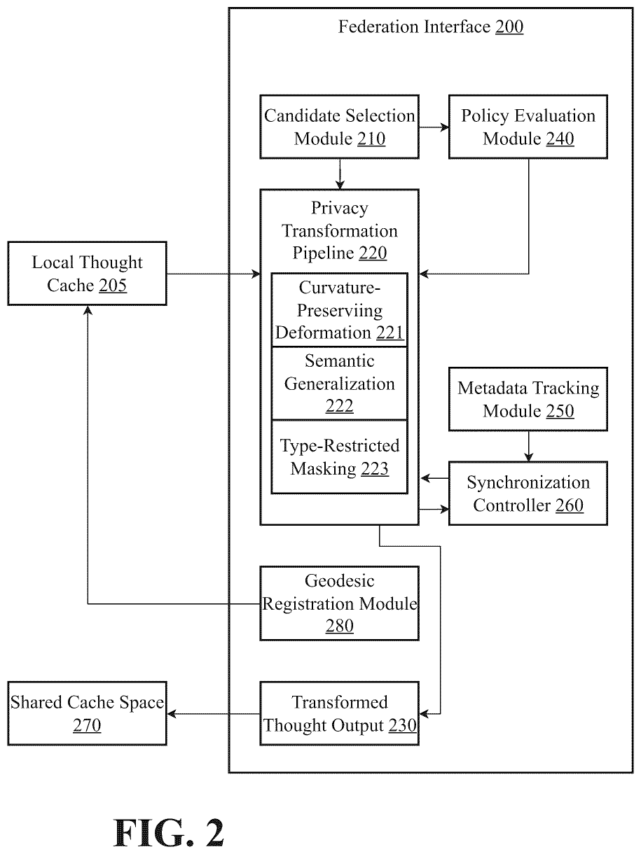

FIG. 2 is a block diagram illustrating an exemplary architecture of a federation interface component within a Persistent Cognitive Machine (PCM), demonstrating the sophisticated pipeline through which instance-specific thoughts are selected, transformed, and prepared for cross-instance sharing while preserving privacy and semantic integrity. The federation interface serves as the critical boundary component that enables distributed cognition across multiple PCM instances by implementing geometric abstraction techniques that allow knowledge sharing without exposing proprietary or sensitive information. This architecture represents the core inventive mechanism that distinguishes federated thought caching from simple data replication, providing a principled framework for collective intelligence that respects instance autonomy.

The architecture receives input from local thought cache 205, which maintains instance-specific thought trajectories γ(t) with full geometric fidelity including complete curvature profiles, metric tensor values, and semantic context. The local thought cache represents the primary memory system for a single PCM instance, containing all thoughts generated through that instance's operational history with their native geometric representations preserved exactly as they were embedded during cognitive processing. These locally cached thoughts include detailed information about the specific operational context, proprietary decision-making patterns, domain-specific knowledge, and instance-unique reasoning strategies that have proven effective for this particular PCM's tasks and environment.

Federation interface 200 serves as the main container orchestrating all processes required to transform local thoughts into shareable representations suitable for federation. This interface implements a multi-stage pipeline that balances competing objectives: maximizing the value of shared knowledge, preserving semantic and geometric integrity of reasoning patterns, protecting instance-specific sensitive information, and ensuring computational efficiency of the federation process. The interface operates continuously, monitoring the local thought cache for candidates worthy of federation while respecting bandwidth constraints, policy requirements, and synchronization schedules that govern cross-instance communication.

Candidate selection module 210 implements the initial filtering stage that identifies which thoughts from local thought cache 205 warrant consideration for federation. This module computes a federation score F(γ) for each cached thought trajectory γ using a weighted combination of multiple criteria that assess the thought's value for cross-instance sharing. The federation score formula F(γ)=αR(γ)+βK(γ)−γ_{d}δ(γ) combines three primary factors with configurable weighting coefficients α, β, and γ_{d} that can be tuned based on federation priorities and operational context. The reuse score R(γ) quantifies how frequently and successfully the thought has been activated in prior cognitive operations, with higher scores indicating stable, validated reasoning patterns that have proven their worth through repeated application. This score is computed not through simple access counting but through weighted contributions that consider the context and outcome of each activation, giving greater weight to thoughts that participated in successful task completion or contributed to valuable insights. The compression value K(γ) measures the thought's generalization potential by assessing how well it captures abstract patterns applicable beyond its specific originating context, using geometric analysis to determine whether the thought represents a reusable template or merely an instance-specific solution. High compression values indicate thoughts that encode transferable reasoning strategies, diagnostic methodologies, or decision frameworks that could benefit other instances operating in related domains. The decay factor δ(γ) derives from the thought's activation energy dynamics according to thermodynamic memory principles, with lower activation energies indicating thoughts that are fading from active use and may not warrant the investment of federation resources.

Only thoughts achieving federation scores F(γ) exceeding a predetermined threshold θ_{f} proceed to the privacy transformation pipeline, ensuring that federation bandwidth and computational resources are devoted to high-value knowledge transfer rather than disseminating marginal or obsolete information. The threshold θ_{f} adapts dynamically based on factors including available network capacity, current federation load across the distributed system, the rate of novel thought generation in the local cache, and strategic priorities that may temporarily emphasize certain types of knowledge sharing over others. This adaptive thresholding ensures that the federation interface responds intelligently to changing operational conditions while maintaining consistent quality standards for shared knowledge.

Privacy transformation pipeline 220 implements a sophisticated three-stage process that progressively abstracts selected thoughts to remove instance-specific details while preserving the essential geometric and semantic structures that make the thoughts valuable for cross-instance application. This pipeline represents the core privacy-preserving mechanism that enables federation without compromising instance autonomy or revealing proprietary information, implementing geometric abstraction techniques that operate on the manifold-level representations of thoughts rather than merely filtering or encrypting surface-level data. The three stages operate sequentially, with each transformation building upon the abstractions created by previous stages to achieve progressively higher levels of privacy protection while maintaining reasoning capability.

Curvature-preserving deformation 221 implements the first transformation stage, applying a diffeomorphism φ: M→M to the thought's geometric representation that maintains global shape and topological structure while obscuring fine-grained local features that might reveal instance-specific details. This transformation operates under the constraint |K(σ)−K(φ(σ))|<ε_{K}, ensuring that sectional curvature along principal directions remains within tolerance ε_{K} of the original values. By preserving curvature patterns, the transformation maintains the semantic density relationships and structural importance markers that are essential for the thought to function as a reasoning template, while the deformation smooths out the precise geometric configurations that encode specific operational parameters, measurement values, or contextual details unique to the originating instance. For example, a diagnostic reasoning trajectory for equipment troubleshooting would retain its overall structure of symptom assessment leading through hypothesis generation to corrective action, but the specific threshold values, timing parameters, and equipment-specific measurements would be smoothed into more generalized ranges that preserve the diagnostic logic without revealing proprietary operational details.

Semantic generalization 222 implements the second transformation stage, operating on typed latent entities within the thought to replace specific instances with categorical abstractions through a generalization map G: e→\tilde{e}. This process identifies entities of various types including facts, concepts, procedures, and references, mapping each to an appropriate higher-level category that preserves semantic relationships while removing specificity. For instance, a specific equipment model identifier “Pump-XJ-2847” might be generalized to the category “centrifugal pump” or even “rotating equipment” depending on the level of abstraction appropriate for the knowledge being shared. Similarly, specific individuals, organizations, locations, or temporal references are replaced with role-based or categorical representations that maintain their functional significance within the reasoning pattern while preventing identification of particular instances. The generalization process employs ontological knowledge about domain hierarchies to select abstraction levels that balance information preservation against privacy protection, applying more aggressive generalization to entities marked as sensitive while maintaining greater specificity for structural elements essential to the reasoning pattern.

Type-restricted masking 223 implements the third transformation stage, applying targeted removal or replacement of sensitive typed entities based on federation policies and regulatory requirements. While the previous stages applied geometric and semantic abstraction to reduce specificity, type-restricted masking provides explicit protection against disclosure of particular categories of information that must not be shared regardless of abstraction level. This stage examines the type annotations associated with latent entities, applying masking operations to categories designated as sensitive including proprietary operational data, personal information subject to privacy regulations, classified or confidential content, trade secrets, and instance-identifying markers. The masking process does not simply delete sensitive entities but rather replaces them with null representations or generic placeholders that maintain trajectory continuity, ensuring that the resulting transformed thought remains geometrically coherent and semantically interpretable despite the removal of sensitive components. Additionally, this stage implements differential privacy techniques by adding calibrated noise to certain geometric features, preventing adversarial reconstruction of sensitive information even through statistical analysis of multiple shared thoughts.

Transformed thought output 230 generates the final representation T(γ) resulting from the complete privacy transformation pipeline, producing a thought that preserves global shape and reasoning structure while successfully obscuring local instance-specific details. This transformed representation maintains the essential characteristics that make the thought valuable for federation: the overall trajectory through semantic space that captures the reasoning flow, the curvature patterns that indicate semantic density and conceptual importance, the topological features that define relationships between components, and the geodesic structure that enables efficient traversal during retrieval and application. However, the transformation has removed or abstracted the fine-grained geometric details, specific entity instances, sensitive operational parameters, and instance-identifying features that could compromise privacy or reveal proprietary information. The output T(γ) exists as a geometric object compatible with the shared cache space representation format, ready for transmission to other federation participants while providing mathematical guarantees about information disclosure limits based on the privacy parameters εK and other transformation constraints applied during the pipeline processing.

Policy evaluation module 240 implements continuous assessment of transformed thoughts against federation policies, regulatory requirements, and strategic objectives before authorizing transmission to the shared cache space. This module performs multi-criteria evaluation that goes beyond the privacy transformations themselves to consider broader implications of knowledge sharing including residual sensitive information checks that employ adversarial analysis techniques to test whether transformed thoughts could be reverse-engineered or combined with other information to reconstruct protected details, regulatory compliance verification ensuring conformance with data sovereignty requirements, industry-specific regulations like HIPAA or GDPR, export control restrictions, and other legal constraints that govern information flow across organizational or jurisdictional boundaries. The module also evaluates reciprocity principles to ensure balanced knowledge exchange between participating instances, tracking the relative contributions and benefits received by each federation participant to prevent exploitation where some instances continuously extract value without providing comparable contributions. Data sovereignty constraints are enforced by examining whether thoughts derived from data subject to location-specific storage or processing requirements can be legally shared with instances in other jurisdictions, implementing geographic restrictions and compliance tracking as needed.

The policy evaluation module maintains bidirectional communication with the privacy transformation pipeline through a feedback control loop, providing guidance for adjustment of transformation parameters when initial outputs fail to meet policy requirements. If the evaluation detects residual sensitive information or policy violations, it can direct the transformation pipeline to apply more aggressive abstraction, additional masking, or alternative generalization strategies until the output achieves acceptable compliance. This iterative refinement continues until either a compliant transformation is achieved or the thought is deemed unsuitable for federation and excluded from the shared cache. The policy evaluation implements configurable rule sets that can be customized based on organizational requirements, domain-specific constraints, and evolving regulatory landscapes, ensuring that the federation interface adapts to changing governance requirements without requiring architectural modifications.

Metadata tracking module 250 maintains comprehensive provenance and tracking information for each transformed thought processed through the federation interface, creating a detailed audit trail that supports transparency, accountability, and trust management within the federated system. For every thought that successfully traverses the transformation pipeline, the metadata module records source instance provenance identifying which PCM instance generated the original thought and when it was created, enabling other instances to assess the credibility and relevance of shared knowledge based on the source's domain expertise and operational history. Transformation parameters applied during the privacy pipeline are logged including the specific deformation functions, generalization mappings, and masking operations used, allowing receiving instances to understand the abstraction level and limitations of the shared knowledge. Trust scores and validation metrics are computed and attached, quantifying the reliability of the thought based on factors such as how many times it has been successfully applied across different instances, whether it has been validated through ground truth comparison, the stability of the thought under perturbation during dreaming processes, and the consistency of the thought with established domain knowledge.

The metadata tracking module maintains this information throughout the lifecycle of federated thoughts, updating metrics as thoughts are used by receiving instances and feeding validation results back to the originating instance. This creates a reputation system where thoughts that prove valuable across multiple diverse contexts gain higher trust scores and preferential treatment in future federation operations, while thoughts that fail to transfer effectively or produce poor results have their scores downgraded and may eventually be pruned from the shared cache. The metadata supports explainable AI capabilities by enabling systems to trace the provenance of conclusions back through the reasoning paths and identify which federated knowledge contributed to specific outputs, providing transparency that is essential for deployment in regulated domains or high-stakes applications.

Synchronization controller 260 manages the timing, prioritization, and transmission protocols for moving transformed thoughts from the local federation interface to the shared cache space, implementing sophisticated scheduling algorithms that optimize the trade-offs between knowledge freshness, network efficiency, and computational overhead. The controller supports multiple synchronization modes that can be selected based on operational requirements and network conditions. Eager synchronization implements immediate transmission of newly transformed thoughts to the shared cache as soon as they complete the privacy transformation pipeline and pass policy evaluation, ensuring minimal latency between local knowledge creation and federation availability but potentially consuming significant network bandwidth if the local instance generates high volumes of shareable thoughts. Lazy synchronization batches multiple transformed thoughts together and transmits them at predetermined intervals or when accumulated batches reach size thresholds, improving network efficiency through reduced protocol overhead and better utilization of available bandwidth but introducing latency between local generation and federation availability. Selective synchronization applies additional filtering based on semantic relevance to other known instances in the federation, transmitting only thoughts that are predicted to benefit specific peer instances based on their operational domains and knowledge gaps, dramatically reducing unnecessary transmission of thoughts that would rarely or never be retrieved by other instances. Adaptive synchronization continuously monitors network conditions including available bandwidth, latency, packet loss, and congestion, dynamically adjusting batch sizes, transmission frequencies, and compression levels to maintain optimal utilization without overwhelming network infrastructure or interfering with other critical communications.

The synchronization controller maintains awareness of the federation topology and state of other instances, tracking which instances are currently online and reachable, which instances have expressed interest in particular knowledge domains, what the last successful synchronization times were with each peer, and what bandwidth allocations or quality-of-service guarantees are in place for federation traffic. This awareness enables intelligent routing decisions where thoughts can be transmitted directly to specific interested instances rather than always broadcasting to all federation participants, reducing network load while ensuring timely delivery of relevant knowledge. The controller also implements retry logic with exponential backoff for handling transmission failures, queue management to prevent memory exhaustion during network outages, and priority scheduling that can expedite transmission of high-value thoughts flagged as critical for ongoing collaborative tasks.

The primary output flow from transformed thought output 230 proceeds to shared cache space 270, which serves as the central repository for federated knowledge accessible to all participating PCM instances. The shared cache space receives generalized thought bundles from multiple federation interfaces across the distributed system, applying additional consolidation and abstraction operations to merge semantically similar contributions from different instances into unified representations that capture collective intelligence. The shared cache implements progressive generalization algorithms that continuously identify opportunities to synthesize higher-order abstractions from collections of specific federated thoughts, creating meta-level reasoning templates that transcend the particulars of any individual instance's experiences. These generalized bundles maintain sufficient geometric structure to enable meaningful retrieval and application by diverse instances while representing knowledge at abstraction levels appropriate for cross-instance sharing.

The bidirectional nature of the federation interface is demonstrated by the retrieval path where thoughts from shared cache space 270 are retrieved and processed through geodesic registration module 280 for integration into the local cognitive structures. When a local PCM instance identifies gaps in its knowledge or seeks expertise from the collective federation, it queries the shared cache space for relevant thought bundles that might address its needs. Retrieved thoughts undergo geodesic registration, which solves an optimization problem to align external geometric representations with the local manifold structure: min_{Φ}∫ₒ¹d²MⱼΦ(T(γ(t))), η(t)) dt, where Φ represents a mapping from the retrieved thought trajectory to the local manifold that minimizes distortion while preserving semantic content. This registration process accounts for the fact that different PCM instances may have evolved distinct geometric structures for representing similar knowledge domains due to different operational histories and contexts, requiring careful transformation to embed external thoughts in ways that integrate smoothly with local cognitive patterns.

Geodesic registration module 280 implements iterative optimization algorithms such as Riemannian gradient descent that respect the curved geometry of the local manifold, searching for alignment mappings that preserve the essential structure of retrieved thoughts while adapting them to local geometric conventions. The module evaluates registration quality through multiple metrics including geodesic distance between the transformed trajectory and locally plausible paths, curvature compatibility between the external thought and local semantic density patterns, semantic coherence measured through consistency with existing local knowledge, and computational cost of traversing the registered thought during future reasoning operations. Successful registration produces an aligned thought representation that can be stored in local thought cache 205, enriching the instance's knowledge base with reasoning patterns and expertise developed by other federation participants.

The complete cycle from local thought cache 205 through the federation interface 200 to shared cache space 270 and back through geodesic registration module 280 to local cache creates a knowledge circulation system that enables distributed cognition across the federated PCM system. Local experiences generate thoughts that are abstracted for sharing, collective knowledge accumulates in the shared cache through contributions from multiple instances, and individual instances enhance their capabilities by retrieving and integrating relevant external knowledge. This circulation implements a form of social learning at the machine level, where diverse operational experiences across the federation contribute to collective intelligence that exceeds the capabilities of any individual instance.

The legend distinguishes between primary data flow shown with thick solid arrows representing the main pathway of thoughts through transformation and transmission, and control/metadata flow shown with dashed arrows representing the feedback signals, policy guidance, and tracking information that coordinate the various modules' operations. Processing steps are visually distinguished through shaded boxes that contain the detailed sub-operations within each major module, helping to clarify the hierarchical organization of the federation interface architecture.

The key innovation highlighted at the bottom of the figure emphasizes that privacy-preserving geometric abstraction represents the fundamental enabling mechanism for federated thought caching, allowing knowledge sharing without exposing instance-specific details. This approach transcends traditional privacy techniques like encryption or access control by operating at the semantic and geometric level, ensuring that shared thoughts are inherently abstract and cannot be reverse-engineered to reveal protected information, even by federation participants who receive and use them. The geometric abstraction preserves precisely the information necessary for reasoning and application while removing precisely the details that create privacy or proprietary concerns, achieving a balance that enables collective intelligence while respecting instance autonomy in a principled, mathematically grounded manner.

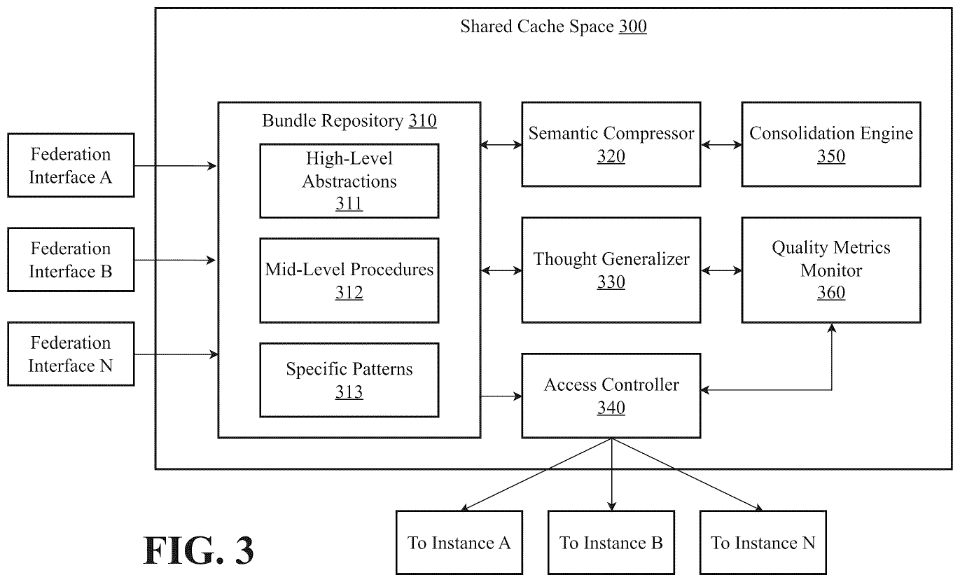

FIG. 3 is a block diagram illustrating an exemplary internal architecture of a shared cache space within a federated Persistent Cognitive Machine system, demonstrating the sophisticated repository and processing infrastructure that enables collective intelligence through progressive consolidation, semantic compression, and quality-driven curation of federated knowledge. The shared cache space operates not as a passive storage system but as an active cognitive component that continuously processes incoming thoughts from multiple PCM instances, identifies opportunities for generalization and consolidation, manages access control based on semantic and policy criteria, and monitors quality metrics to ensure that federated knowledge maintains high standards of coherence and applicability. This architecture implements the mechanisms through which distributed experiences across multiple autonomous instances converge into unified representations that capture collective intelligence while respecting the diversity and autonomy of individual participants.

Shared cache space 300 serves as the main container encompassing all components and processes involved in managing federated knowledge, receiving transformed thoughts from multiple federation interfaces, processing these contributions through various refinement and consolidation operations, and providing retrieval services to requesting instances seeking to enhance their local capabilities with collective knowledge. The shared cache space maintains awareness of the complete federation topology including which instances are active participants, what domains each instance specializes in, what knowledge contributions each has made historically, and what retrieval patterns indicate about each instance's needs and interests. This comprehensive awareness enables intelligent management decisions about storage allocation, consolidation priorities, and access optimization that improve the overall efficiency and effectiveness of the federated cognitive system.

Multiple input streams on the left side of the figure demonstrate the federated nature of the system, with transformed thoughts arriving from various PCM instances distributed across the federation. Federation Interface A provides transformed thoughts T_{A}(γ) representing knowledge derived from Instance A's operational experiences, having already undergone privacy-preserving transformations including curvature-preserving deformation, semantic generalization, and type-restricted masking as described in the federation interface architecture. These incoming thoughts carry not just content but also rich metadata about their provenance, transformation parameters, and validation status within their originating instance. Federation Interface B similarly contributes transformed thoughts T_{B}(γ) reflecting Instance B's distinct operational domain and accumulated expertise, which may differ substantially from Instance A due to different application contexts, sensor configurations, task objectives, or operational histories. The ellipsis notation indicates that the federation can scale to arbitrary numbers of participating instances, with Federation Interface N representing the Nth instance in a potentially large-scale distributed cognitive system. Each input stream operates asynchronously, with instances contributing knowledge according to their own generation rates, synchronization schedules, and network connectivity, creating a continuous flow of new experiences and insights into the shared cache space that must be integrated coherently despite arriving at unpredictable intervals and in varying volumes.

Bundle repository 310 implements the primary storage infrastructure for federated knowledge, organizing thought bundles into a hierarchical structure that reflects different levels of abstraction and generalization appropriate for cross-instance sharing. Unlike flat storage systems that treat all items uniformly, the bundle repository recognizes that federated knowledge naturally stratifies into layers based on abstraction level, domain specificity, and applicability breadth, implementing storage policies and retrieval optimizations tailored to each layer's characteristics. The repository maintains comprehensive metadata for each bundle enabling sophisticated queries, access control decisions, and consolidation operations that go far beyond simple key-value retrieval, tracking the complete lifecycle of federated knowledge from initial contribution through iterative refinement to eventual obsolescence or elevation to higher abstraction levels.

High-level abstractions 311 occupy the top tier of the hierarchical repository, containing broad conceptual frameworks and domain-agnostic reasoning patterns that have proven valuable across diverse operational contexts and multiple instances. These bundles represent the most generalized knowledge in the federation, having typically emerged through progressive consolidation of many instance-specific thoughts that, despite surface differences, revealed common underlying structures when analyzed geometrically. Sample bundles labeled α, β, γ, and δ illustrate the discrete nature of storage at this level, where each bundle represents a distinct high-level reasoning pattern such as general problem-solving methodologies, abstract decision frameworks applicable across domains, universal optimization principles, or fundamental diagnostic strategies. High-level abstractions exhibit relatively flat internal geometry reflecting their lack of domain-specific detail, making them efficiently traversable and broadly applicable but requiring instantiation with context-specific information when applied to concrete problems. These bundles typically have the longest persistence in the shared cache, as they represent knowledge validated across the broadest range of contexts and thus least likely to become obsolete as individual instances' operational environments evolve.

Mid-level procedures 312 occupy the middle tier, containing domain-specific methodologies and anonymized technical procedures that have been abstracted from particular equipment or systems but retain sufficient specificity to be immediately actionable within appropriate domains. These bundles represent a sweet spot in the abstraction hierarchy where knowledge is general enough to transfer across instances operating in similar domains while remaining specific enough to provide concrete guidance for operational tasks. Sample bundles ε, ζ, η, and θ might represent, for example, diagnostic procedures for classes of equipment like “rotating machinery troubleshooting” that abstract away specific model numbers and manufacturers while preserving the essential diagnostic logic, decision frameworks for resource allocation under various constraint types, procedural templates for safety-critical operations that capture regulatory requirements without encoding facility-specific details, or optimization strategies for particular classes of operational problems. Mid-level procedures exhibit moderate internal curvature reflecting their domain-specific semantic density, requiring more effort to traverse than high-level abstractions but offering greater immediate utility for instances operating within the relevant domains. The repository tracks domain tags and applicability metadata for mid-level bundles, enabling instances to efficiently discover procedures relevant to their operational contexts while avoiding retrieval of inapplicable knowledge from unrelated domains. Specific patterns 313 occupy the bottom tier, containing detailed reasoning sequences and

context-adapted templates that provide the most concrete guidance but have narrower applicability ranges than higher-level knowledge. These bundles represent thoughts that have proven valuable enough to federate but have not yet been generalized into broader procedures, either because insufficient similar experiences have accumulated to warrant abstraction or because they contain genuinely unique patterns specific to particular operational scenarios. Sample bundles ι, κ, λ, and μ might encode detailed response sequences for rare but important edge cases, specialized techniques for handling unusual parameter combinations, creative solutions to novel problems that worked but haven't been validated across multiple contexts, or recent innovations that are being shared tentatively pending broader validation. Specific patterns exhibit the highest internal curvature among shared bundles, reflecting their detailed semantic content and tight coupling to particular contexts, making them more expensive to traverse and requiring more careful alignment when retrieved by other instances. The repository implements more aggressive decay policies for specific patterns compared to higher-level knowledge, removing patterns that fail to see repeated use or that cannot be consolidated into more general forms, ensuring that storage resources focus on knowledge with demonstrated cross-instance value.

The metadata section within bundle repository 310 maintains comprehensive tracking information essential for intelligent federation management. For each bundle regardless of abstraction level, the repository records generalization level as a quantitative measure of abstraction degree, enabling instances to request knowledge at appropriate specificity for their needs and guiding consolidation decisions about when specific patterns should be elevated to mid-level procedures. Contributing instances are tracked through provenance chains identifying which PCM instances provided the original thoughts that contributed to each bundle's formation, enabling trust-based filtering where instances can preferentially retrieve knowledge from sources with demonstrated expertise in relevant domains. Semantic coverage defines the domain scope and applicability boundaries of each bundle through structured tags, ontological annotations, and geometric descriptors that characterize what regions of semantic space the bundle addresses, facilitating efficient discovery of relevant knowledge while avoiding inappropriate application of domain-specific bundles to contexts where their assumptions don't hold. Stability metrics quantify validation consistency across multiple instances and diverse contexts, tracking how reliably the bundle transfers and produces expected results when applied in different operational environments, with high stability indicating robust generalizations while low stability may trigger additional validation requirements or flag bundles for refinement. Usage statistics record retrieval frequency across the federation, identifying hot bundles that warrant optimization for rapid access versus cold bundles that may be candidates for archival or removal, while also detecting usage patterns that suggest opportunities for creating derived bundles optimized for particular access patterns. Trust scores aggregate validation results from multiple instances, implementing a reputation system where bundles that consistently produce good results across diverse applications earn higher trust while those that frequently fail or produce poor outcomes have scores downgraded, influencing both retrieval prioritization and consolidation decisions. Timestamps track last update times enabling staleness detection, version control during concurrent modifications, and temporal analysis of knowledge evolution patterns that reveal how the federation's collective understanding develops over time.

Semantic compressor 320 implements aggressive data reduction algorithms that minimize storage requirements and transmission bandwidth while preserving the essential geometric and semantic structures that make thoughts valuable for cross-instance reasoning. This component operates on the principle that federated knowledge should be maximally compressed to enable efficient storage and rapid transmission while maintaining sufficient information for meaningful reconstruction and application by receiving instances. The compressor receives incoming thoughts from federation interfaces through dashed arrows indicating control flow, analyzes their geometric and semantic structures, and produces compressed representations that are stored in bundle repository 310 through solid arrows indicating primary data flow. The compression process is adaptive, applying different strategies and aggressiveness levels based on the abstraction tier where the bundle will be stored, with high-level abstractions receiving the most aggressive compression since they should retain only the essential structural patterns while specific patterns receive gentler compression to preserve their detailed content.

Geometric simplification represents the first compression technique, reducing the dimensionality of thought representations while preserving topological features that encode essential semantic relationships. This process projects high-dimensional local trajectories onto lower-dimensional manifolds that capture the principal variations and critical decision points while eliminating redundant dimensions that encode instance-specific details or measurement noise. The simplification employs techniques from differential geometry including principal geodesic analysis to identify the directions of maximal semantic variation, topological data analysis to preserve critical features such as holes, connected components, and homotopy groups that encode structural relationships, and manifold learning algorithms that discover intrinsic dimensionality and project thoughts onto minimal representations that maintain geodesic distances and local neighborhood structures. For example, a detailed troubleshooting trajectory through hundreds of dimensions encoding every sensor reading and intermediate calculation might be simplified to a trajectory through dozens of dimensions that capture only the essential diagnostic decision points and state transitions, reducing storage by an order of magnitude while preserving the diagnostic logic.

Conceptual abstraction implements the second compression technique, replacing specific entity instances with categorical representations while maintaining logical relationships and reasoning structures. This process analyzes typed latent entities within thoughts, identifies appropriate abstraction levels for each entity based on semantic ontologies and domain knowledge, and performs substitutions that generalize without destroying semantic coherence. For instance, specific equipment identifiers are replaced with equipment class labels, particular numerical values are converted to qualitative ranges or symbolic representations, individual names are substituted with role descriptors, and temporal references are abstracted to relative timing relationships. The abstraction process must carefully preserve dependencies and relationships between entities, ensuring that logical constraints, causal chains, and functional relationships remain intact despite entity generalization. This enables the compressed thought to serve as a template that can be instantiated with different concrete entities while maintaining valid reasoning structure.

Trajectory summarization implements the third compression technique, extracting essential waypoints from reasoning sequences while removing redundant intermediate steps that don't contribute critical information to the overall pattern. This process analyzes thought trajectories to identify key decision points where significant state changes occur, critical observations that trigger reasoning transitions, important conclusions that feed into subsequent processing, and essential boundary conditions that constrain the trajectory's behavior. Intermediate computational steps, exploratory branches that were abandoned, temporary states that quickly transition to more stable configurations, and verbose elaborations that don't add semantic information are removed or collapsed into summaries. The summarization employs techniques including critical point detection to identify trajectory segments with high curvature or rapid state change, information-theoretic measures to quantify the contribution of each waypoint to overall trajectory information content, and geometric simplification algorithms that approximate complex trajectory segments with simpler paths that maintain semantic equivalence within tolerance.

Thought generalizer 330, also identified as the latent recombinator, implements the sophisticated pattern synthesis operations that create higher-order abstractions from collections of related thoughts, enabling the emergence of collective intelligence that transcends individual instances' contributions. This component continuously analyzes bundles within the repository through bidirectional arrows indicating its ability to both retrieve bundles for analysis and store newly synthesized generalizations back into the repository. The generalizer operates during both active federation when new thoughts arrive and during background curation cycles when the system has idle computational resources, implementing progressive abstraction that gradually elevates specific patterns through mid-level procedures to high-level abstractions as accumulating evidence validates their broader applicability.

Trajectory alignment represents the first generalization operation, identifying similar reasoning paths across different geometric contexts and instances through sophisticated matching algorithms that account for the fact that semantically equivalent reasoning may be embedded differently in distinct local manifolds. The alignment process computes correspondence maps between trajectories from different instances, using techniques such as dynamic time warping adapted for curved manifolds to handle trajectories of different lengths and temporal scales, geodesic distance minimization to find optimal alignment that preserves geometric structure, and semantic similarity scoring based on shared conceptual content despite different geometric embeddings. When the alignment identifies multiple trajectories that follow similar reasoning patterns despite originating from different instances and contexts, it marks them as candidates for synthesis into a unified generalized pattern that captures the common structure. For example, diagnostic procedures from multiple industrial facilities might follow similar logic of symptom assessment, hypothesis generation, and corrective action despite operating on different equipment models and having different local geometric embeddings, enabling synthesis of a generalized diagnostic framework.

Semantic clustering represents the second generalization operation, grouping related thoughts despite surface-level differences through analysis of their deeper semantic content and functional roles. The clustering employs techniques including manifold-aware similarity measures that account for curvature and metric structure when computing distances between thoughts, content analysis examining the types, relationships, and logical structures within thoughts regardless of specific entity instances, and functional equivalence detection identifying thoughts that achieve similar reasoning outcomes through potentially different intermediate steps. The clustering algorithms must handle the challenges that thoughts from different instances may use different vocabularies, encoding schemes, and geometric embeddings while still representing fundamentally similar knowledge, requiring robust similarity measures that focus on structural and semantic patterns rather than surface features. Identified clusters represent opportunities for generalization where multiple similar thoughts can be replaced by a single abstracted representation that captures their common essence while requiring less storage and providing clearer expression of the underlying pattern.

Weighted interpolation represents the third generalization operation, implementing the mathematical synthesis that actually creates new meta-representations from collections of related thoughts. The interpolation follows the formula zₘₑₜₐ=Σαᵢz′ᵢ where z′ᵢ represents perturbed or aligned versions of the original thoughts and αᵢ represents weights that sum to unity, indicating the relative contribution of each source thought to the final generalization. The weights are determined through multiple criteria including validation strength reflecting how consistently each source thought has performed across different contexts, semantic centrality measuring how representative each thought is of its cluster, geometric stability quantifying how resistant each thought is to perturbation and variation, and instance diversity favoring generalizations that synthesize knowledge from multiple independent sources rather than over-representing any single instance's perspective. The interpolation process must maintain geometric coherence, ensuring that the synthesized meta-thought zₘₑₜₐ lies within valid regions of the latent manifold and preserves topological and curvature properties that encode semantic relationships. The resulting generalization is not simply an average but a carefully constructed new representation that may occupy regions of the manifold not directly visited by any contributing thought, capturing emergent patterns that become apparent only when multiple instances' experiences are synthesized.

Access controller 340 implements sophisticated permission and policy enforcement mechanisms that determine which instances can retrieve which bundles from the shared cache, enabling privacy-preserving federation where sensitive knowledge remains restricted while broadly applicable patterns are widely shared. The controller receives bundle access requests through dashed arrows indicating control flow from the bundle repository, evaluates these requests against multiple criteria, and either authorizes retrieval or denies access based on the evaluation results. This component implements differential access policies where different instances may have different levels of access to the shared cache based on their demonstrated trustworthiness, domain expertise, contribution history, and organizational affiliations, creating a nuanced federation model that goes beyond simple all-or-nothing sharing.

Semantic alignment represents the first access control criterion, evaluating whether the requesting instance's query demonstrates sufficient semantic compatibility with the bundle's content to warrant access. The evaluation examines the geometric properties of the query trajectory, comparing its curvature patterns, dimensional structure, and topological features against the bundle's characteristics to assess whether the instance's local manifold can meaningfully accommodate the bundle through geodesic registration. If the semantic distance between query and bundle exceeds thresholds indicating fundamentally incompatible representations, access may be denied not for policy reasons but because the bundle would not transfer effectively, saving bandwidth and computational resources on futile retrieval attempts. This criterion implements a form of automatic relevance filtering where instances naturally discover bundles appropriate to their operational contexts while avoiding exposure to irrelevant knowledge from unrelated domains.

Demonstrated competence represents the second access control criterion, validating that the requesting instance has sufficient expertise in the relevant domain to effectively utilize and properly interpret the requested bundle. The evaluation examines the instance's contribution history to assess whether it has previously generated or successfully applied knowledge in the same or related domains, retrieval patterns to identify whether the instance shows consistent interest and engagement with particular knowledge areas suggesting genuine operational need rather than casual browsing, and validation feedback from previous retrievals to verify that the instance successfully integrated similar bundles in the past. This competence-based filtering prevents inappropriate access where novice instances might misapply advanced knowledge they lack the context to interpret correctly, while ensuring that expert instances receive ready access to sophisticated bundles appropriate to their capabilities. The criterion implements a form of progressive revelation where instances gradually gain access to more advanced knowledge as they demonstrate competence through successful application of foundational patterns.

Privacy constraints represent the third access control criterion, enforcing restrictions that may be embedded in bundles based on their source provenance, content sensitivity, or regulatory requirements. The evaluation checks whether bundles derived from particular instances are subject to sharing restrictions that limit access to specific federation members, whether content categories are flagged as sensitive requiring special authorization or compliance certification from requesting instances, whether regulatory frameworks such as export controls, data protection laws, or industry-specific regulations prohibit transfer to certain jurisdictions or organizations, and whether the requesting instance has signed appropriate agreements or demonstrated compliance with security standards required for accessing sensitive knowledge. These privacy constraints ensure that federation respects not just technical compatibility but also legal, regulatory, and organizational boundaries that govern information sharing in real-world deployments.

Federation agreements represent the fourth access control criterion, implementing consortium-level policies that define sharing relationships between groups of instances based on organizational affiliations, business relationships, or collaborative arrangements. The evaluation examines whether the requesting instance belongs to organizations or consortia that have established sharing agreements with the bundle's contributing instances, whether reciprocity principles are satisfied indicating balanced knowledge exchange rather than one-way extraction, whether service level agreements or quality-of-service guarantees are being honored regarding both knowledge contribution and retrieval patterns, and whether any outstanding conflicts, disputes, or policy violations would warrant restricting the requesting instance's access pending resolution. Federation agreements enable flexible collaboration models including fully open sharing within trusted consortia, bilateral exchange between partner organizations, tiered access where different membership levels receive different degrees of access, and dynamic policies that adapt based on evolving relationships and participation patterns.

Consolidation engine 350 implements the progressive abstraction and merger operations that enable logarithmic scaling of storage requirements despite linear growth in processed experiences, representing a fundamental innovation that distinguishes federated thought caching from traditional memory systems that suffer from unsustainable linear or super-linear growth. The engine continuously analyzes bundle repository 310 through bidirectional arrows, identifying opportunities for consolidation, executing merger and abstraction operations, and monitoring the resulting efficiency improvements. This component operates primarily during background cycles when computational resources are available, implementing the dreaming-like processes that reorganize the shared cache to maintain optimal efficiency without disrupting active federation operations. The engine also coordinates with semantic compressor 320 through dashed control flow arrows, ensuring that consolidation operations employ appropriate compression strategies for the resulting abstraction levels.

Bundle merging represents the first consolidation operation, identifying overlapping thoughts within the same abstraction tier that exhibit sufficient similarity to warrant combination into unified representations. The merging process evaluates geometric proximity using geodesic distance measures that account for manifold curvature, semantic overlap through content analysis examining shared entities, relationships, and reasoning structures, and functional equivalence assessing whether bundles produce similar outcomes when applied to comparable problems. When merging criteria are satisfied, the engine applies curvature-weighted averaging or more sophisticated synthesis operations to create a single bundle that captures the combined information content of the sources while occupying less storage than maintaining them separately. The merged bundle inherits metadata from its sources including provenance tracking from all contributing instances, consolidated usage statistics reflecting the combined access patterns, and enhanced trust scores based on validation across multiple source contexts. Merging primarily affects specific patterns 313 and mid-level procedures 312, gradually reducing population at these levels as experience accumulates and similar patterns are unified.

Redundancy elimination represents the second consolidation operation, removing duplicate or near-duplicate representations that arise when multiple instances independently develop similar thoughts and contribute them through their federation interfaces. Unlike merging which creates new unified representations, redundancy elimination simply removes inferior copies while retaining the highest-quality exemplar based on criteria including geometric coherence and smoothness, validation strength across multiple instances, metadata completeness and quality, and recency of contribution. The elimination process must carefully preserve provenance information even when removing redundant copies, ensuring that all contributing instances receive proper credit and that the retained exemplar's metadata reflects the collective validation represented by multiple independent discoveries. Redundancy elimination provides immediate storage savings without requiring synthesis of new representations, operating as a lightweight maintenance operation that can execute more frequently than full consolidation cycles.

Hierarchy formation represents the third consolidation operation, elevating collections of related thoughts from lower abstraction tiers to higher levels when accumulating evidence demonstrates broader applicability than originally recognized. The formation process identifies clusters of specific patterns 313 that share common structural elements suggesting an underlying procedural template, analyzes these patterns to extract the common framework while cataloging the variations that distinguish specific instances, synthesizes a new mid-level procedure 312 that captures the template while supporting parameterization to accommodate the observed variations, and establishes inheritance relationships where the specific patterns are marked as instances or specializations of the new procedure. Similar elevation occurs from mid-level procedures 312 to high-level abstractions 311 when cross-domain validation reveals universal principles underlying domain-specific methodologies. This hierarchical progression gradually shifts the federation's knowledge distribution toward higher abstraction levels as collective experience reveals deeper patterns, explaining the logarithmic scaling behavior where the total number of distinct bundles B(N) grows as κ log(N+1) for some scaling constant k despite processing N experiences, because new experiences are increasingly absorbed into existing high-level abstractions rather than requiring entirely new representations.

Quality metrics monitor 360 implements continuous assessment of bundle quality across multiple dimensions, providing feedback that guides consolidation decisions, access prioritization, and curation policies throughout the shared cache space. The monitor tracks comprehensive metrics for every bundle through dashed control flow connections to bundle repository 310, computing scores that influence whether bundles are promoted, retained, downgraded, or removed from the shared cache. This component implements a fitness-based selection pressure on federated knowledge where high-quality bundles that prove valuable across diverse contexts receive preferential treatment and longer retention while low-quality bundles that fail validation or see limited use are aggressively consolidated or pruned.

Semantic coherence represents the first quality dimension, measuring local manifold smoothness around bundles to detect geometric anomalies that might indicate poorly formed or inconsistent representations. The coherence assessment computes curvature continuity examining whether the bundle exhibits smooth transitions in sectional curvature without abrupt discontinuities that would impede geodesic traversal, metric consistency verifying that distance relationships satisfy triangle inequality and other metric axioms without pathological violations, and neighborhood structure analyzing whether nearby points in the manifold space correspond to semantically related concepts as expected. Low semantic coherence scores indicate bundles that may have resulted from incomplete abstraction, corruption during transmission, or failed consolidation attempts, triggering re-evaluation, repair through re-synthesis from source thoughts if available, or removal if the bundle cannot be salvaged. High coherence scores indicate well-formed bundles that integrate smoothly into the semantic structure of the shared cache, warranting retention and potential elevation to higher abstraction tiers.

Cross-instance applicability represents the second quality dimension, measuring how successfully bundles transfer and produce expected results when retrieved by different instances operating in diverse contexts. The applicability assessment tracks transfer success rates recording the proportion of retrieval attempts that result in successful geodesic registration and integration into requesting instances' local manifolds, outcome validation comparing results achieved using the federated bundle against ground truth or alternative approaches to verify that the bundle actually improves performance, contextual breadth cataloging the diversity of operational environments where the bundle has been successfully applied, and adaptation stability assessing whether the bundle maintains effectiveness under the geometric transformations required for alignment to different local manifolds. High cross-instance applicability indicates robust generalizations that capture transferable patterns independent of instance-specific peculiarities, representing the most valuable contributions to collective intelligence that warrant prominent storage and active promotion to requesting instances. Low applicability suggests bundles that may be over-fitted to their originating contexts or that encode assumptions not holding generally, prompting refinement through additional abstraction or demotion to more restricted access policies where only closely related instances can retrieve them.

Stability under perturbation represents the third quality dimension, quantifying how resistant bundles are to variation, noise, and imperfect alignment when applied in operational contexts that differ from their training or origination environments. The stability assessment applies controlled perturbations to bundles during dreaming cycles, measuring sensitivity of reasoning outcomes to small geometric deformations, resilience to entity substitutions testing whether replacing specific instances with alternative but semantically similar entities maintains reasoning validity, and graceful degradation under incomplete information verifying that bundles can still provide useful guidance when some components are missing or uncertain. High stability indicates bundles that encode robust principles rather than brittle procedures dependent on exact conditions, suggesting they will remain valuable as operational contexts evolve and new instances with different configurations join the federation. Low stability flags bundles that may require refinement to identify and abstract away dependencies on specific conditions, or may indicate genuinely context-specific knowledge that should be clearly labeled with applicability constraints to prevent misapplication in inappropriate contexts.

Compression efficiency represents the fourth quality dimension, assessing the trade-off between storage resources consumed by each bundle and the fidelity with which it preserves essential semantic content and reasoning capability. The efficiency assessment computes information density measuring the ratio of semantic information content to storage requirements, reconstruction accuracy testing whether thoughts synthesized from the compressed bundle maintain equivalence with source thoughts within acceptable tolerances, and marginal utility analyzing whether the bundle provides reasoning capabilities not available through existing bundles or whether it represents redundant information. High compression efficiency indicates bundles that achieve optimal balance between compact representation and semantic fidelity, representing successful abstraction that captures essential patterns in minimal form. Low efficiency suggests opportunities for additional compression through more aggressive abstraction, or may indicate that the bundle represents marginal knowledge that doesn't warrant the storage overhead and should be removed to focus resources on higher-value contributions. The efficiency metric provides quantitative guidance for storage allocation decisions, ensuring that the shared cache maintains optimal density where every bundle justifies its resource consumption through demonstrated value.

The output streams on the right side of the figure demonstrate how federated knowledge flows back from the shared cache space to individual PCM instances, completing the knowledge circulation cycle that enables distributed cognition. These streams connect through access controller 340 which mediates all outgoing retrievals according to the access control policies described previously, ensuring that only authorized and appropriate bundles are transmitted to requesting instances. The multiple output paths to Instance A, Instance B, and Instance N (with ellipsis indicating arbitrary scalability) illustrate that the shared cache serves all federation participants simultaneously, handling concurrent retrieval requests from multiple instances while maintaining consistency and quality of service across the distributed system.

Retrieved bundles flow to each instance with annotation indicating they are destined for geodesic registration and integration into the respective local manifolds M_{A}, M_{B}, M_{N} as described in the federation interface architecture. This registration process represents the critical transformation that adapts abstract federated knowledge to the specific geometric structure of each receiving instance's local manifold, solving the optimization problem that minimizes distortion while preserving semantic content and reasoning capability. The successful execution of geodesic registration enables instances to enhance their capabilities with knowledge developed by others, creating a form of machine social learning where the collective experience of the federation becomes available to individual participants while respecting their autonomous geometric structures and operational contexts.

The feedback loop shown with dashed arrows flowing from the bottom right back through quality metrics monitor 360 to thought generalizer 330 implements the validation and reputation mechanisms that ensure the shared cache evolves toward higher quality through collective intelligence. As instances retrieve bundles, apply them in their operational contexts, and observe results, they generate validation feedback reporting whether the bundles transferred successfully, whether they produced expected reasoning outcomes, whether they required substantial adaptation or worked smoothly, and whether they provided value compared to locally developed alternatives. This feedback flows back to the shared cache where quality metrics monitor 360 incorporates it into bundle scoring, thought generalizer 330 uses it to guide synthesis and consolidation decisions, and access controller 340 adjusts trust scores and access policies based on accumulating evidence. The feedback creates an evolutionary dynamic where bundles that prove valuable across diverse instances and contexts are reinforced through higher quality scores, preferential access, and incorporation into higher-level abstractions, while bundles that consistently fail validation or produce poor results are downgraded and eventually pruned from the cache. This collective validation transcends any individual instance's assessment, providing robust quality signals that reflect true cross-context utility rather than idiosyncratic local preferences.

The legend clarifies the multiple types of information flow shown in the diagram, distinguishing primary data flow carrying actual thought bundles and representations using thick solid arrows, control and monitoring flow carrying metadata, metrics, and coordination signals using dashed arrows, and bidirectional exchange supporting both read and write operations between components using double-ended arrows. The bundle icon illustrates the visual representation used throughout the diagram to indicate stored thought bundles at various abstraction levels, making it easy to identify storage elements versus processing components. This visual vocabulary enables clear comprehension of the complex interactions between components that collectively implement the shared cache space functionality.

The key insight highlighted at the bottom emphasizes the two fundamental properties that distinguish this architecture from traditional distributed storage systems. Logarithmic scaling through progressive consolidation represents the mathematical foundation enabling sustainable long-term operation, where storage requirements grow as κ log(N) rather than linearly with the number of processed experiences N because new contributions are increasingly absorbed into existing high-level abstractions rather than requiring proportional storage expansion. This scaling behavior emerges naturally from the consolidation engine's 350 operations that continuously merge, abstract, and elevate bundles toward higher generalization levels, creating an information compression dynamic that accelerates as more experience accumulates and deeper patterns become apparent. Emergent collective intelligence from cross-instance validation represents the cognitive foundation enabling distributed cognition that exceeds individual capabilities, where the federated system develops understanding and capabilities that no single instance possesses through the synthesis of diverse experiences validated across multiple independent contexts. This collective intelligence emerges from thought generalizer's 330 synthesis operations guided by quality metrics monitor's 360 validation signals, creating representations that capture universal patterns validated across the full diversity of federation contexts rather than merely aggregating individual instances' knowledge. Together, these properties transform the shared cache space from a passive repository into an active intelligence substrate where collective understanding continuously evolves and improves through the natural dynamics of consolidation, validation, and synthesis operating across the distributed federation.

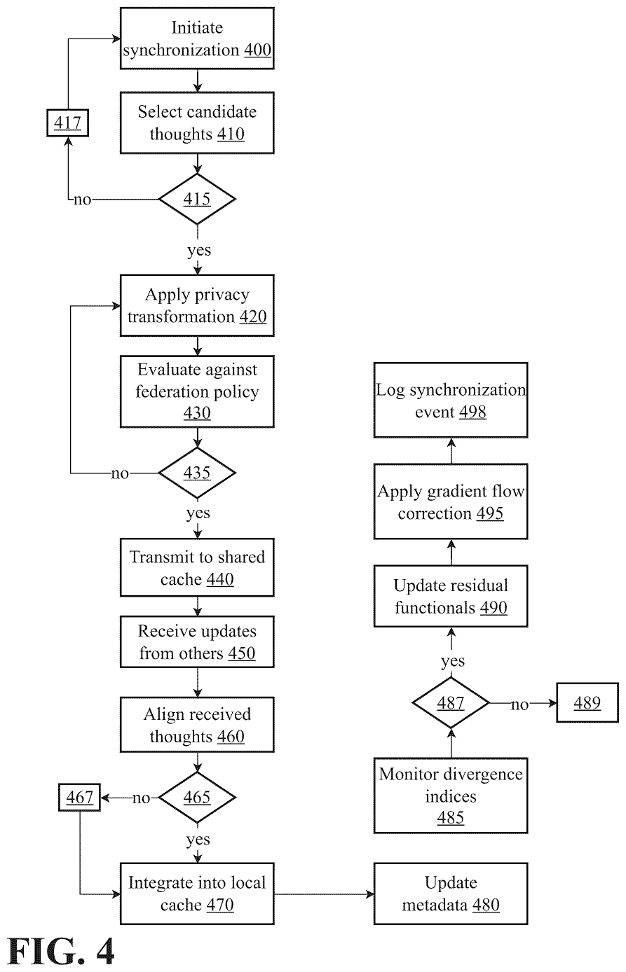

FIG. 4 is a flow diagram illustrating an exemplary method for implementing federated synchronization of cached thoughts across distributed Persistent Cognitive Machine instances with privacy-preserving transformations, conflict resolution, and metacognitive governance mechanisms that maintain coherence while respecting instance autonomy. The method implements a complete synchronization cycle encompassing the selection of candidate thoughts for federation, their transformation to protect sensitive information, transmission to the shared cache space, retrieval and alignment of knowledge from other instances, and continuous monitoring of cross-instance divergence with corrective actions when necessary. This comprehensive process enables distributed cognition where multiple autonomous PCM instances contribute to and benefit from collective intelligence while maintaining their independent operational identities and protecting proprietary information through geometric abstraction techniques operating at the manifold level.

The method begins at step 400 with initiation of synchronization, which may be triggered by multiple mechanisms reflecting the adaptive nature of federation protocols. Time interval triggers activate synchronization at predetermined periods such as hourly, daily, or weekly cycles depending on the rate of new knowledge generation and network capacity constraints, ensuring regular knowledge exchange without overwhelming the federation infrastructure. Usage metrics triggers activate when accumulated cognitive activity exceeds thresholds indicating sufficient new valuable thoughts have been generated to warrant federation, implementing demand-driven synchronization that responds to actual knowledge production rates rather than arbitrary schedules. Remote requests from other instances can also trigger synchronization when peer PCM instances identify knowledge gaps that this instance might fill, enabling targeted knowledge transfer responsive to specific needs across the federation. Event-driven triggers may activate upon completion of significant cognitive tasks, resolution of complex reasoning problems, or discovery of novel patterns that warrant immediate sharing with the federation. The synchronization initiation evaluates current network conditions, computational load, and federation priorities to determine optimal timing and scope for the synchronization cycle, potentially deferring non-urgent updates during high-load periods or expediting critical knowledge during collaborative problem-solving scenarios.

Step 410 implements candidate selection through quantitative scoring that identifies which thoughts from the local cache warrant consideration for federation based on their demonstrated value, generalization potential, and current activation state. The selection process computes a federation score F(γ) for each cached thought trajectory γ according to the formula F(γ)=αR(γ)+βK(γ)−γ_{d}δ(γ), where α, β, and γ_{d} represent configurable weighting coefficients that can be tuned to emphasize different selection criteria based on federation strategy and operational context. The reuse score R(γ) quantifies how frequently and successfully the thought has been activated during prior cognitive operations, computed not through simple access counting but through weighted contributions considering the outcome quality of interactions where the thought participated, with higher scores assigned to thoughts that contributed to successful task completion, enabled valuable insights, or facilitated efficient reasoning. The compression value K(γ) measures the thought's generalization potential by assessing whether it captures abstract patterns applicable beyond its specific originating context, using geometric analysis of the thought's manifold representation to determine whether it exhibits the smoothness, low curvature variation, and broad semantic coverage characteristic of reusable templates versus the high curvature and tight semantic coupling indicating instance-specific solutions. The decay factor δ(γ) derives from the thought's activation energy according to thermodynamic memory principles, with higher decay factors indicating thoughts that are fading from active use and may not warrant federation resource investment. Only thoughts achieving federation scores exceeding the predetermined threshold θ_{f} proceed to privacy transformation, ensuring that federation bandwidth and computational resources focus on high-value knowledge transfer rather than disseminating marginal or obsolete information.

Decision point 415 evaluates whether the selection process identified any candidate thoughts meeting the federation criteria, branching to different paths based on the outcome. If no candidates are found, the method proceeds to step 417 which implements a waiting period before the next synchronization cycle, avoiding wasteful repeated execution when the local cache contains no new thoughts worthy of federation. This waiting state may involve scheduling the next synchronization attempt based on predicted knowledge generation rates, entering a low-power monitoring mode that watches for triggers warranting earlier activation, or adapting the threshold Of if extended periods pass without identifying candidates, indicating that current criteria may be too stringent for the operational context. If candidates are found, the method proceeds with the yes branch to privacy transformation, continuing the synchronization pipeline with thoughts that have demonstrated sufficient value to justify the processing and transmission overhead of federation.

Step 420 applies privacy transformations through a three-stage pipeline that progressively abstracts candidate thoughts to remove instance-specific details while preserving essential geometric and semantic structures enabling cross-instance reasoning. Curvature-preserving deformation represents the first transformation substep, applying a diffeomorphism φ: M→M to each candidate thought's geometric representation that maintains global shape and topological structure while smoothing fine-grained local features that might reveal instance-specific operational parameters or contextual details. This transformation operates under the constraint |K(σ)−K(φ(σ))|<ε_{K} where K(σ) represents sectional curvature along principal directions, ensuring that curvature remains within tolerance ε_{K} of original values to preserve the semantic density relationships and structural importance markers essential for the thought to function as a reasoning template. The deformation employs sophisticated algorithms from differential geometry including Ricci flow-inspired methods that naturally smooth geometric irregularities while preserving topological invariants, harmonic map techniques that minimize distortion energy while transforming between manifold representations, and constrained optimization approaches that respect curvature preservation requirements while maximizing privacy through local feature smoothing. Semantic generalization represents the second substep, operating on typed latent entities within thoughts to replace specific instances with categorical abstractions through the generalization map G: e→\tilde{e}. This process examines entities of various types including facts, concepts, procedures, equipment identifiers, numerical measurements, temporal references, and location markers, mapping each to appropriate higher-level categories that preserve semantic relationships while removing specificity that could identify particular operational contexts, equipment configurations, or organizational details. The generalization employs hierarchical ontologies to select abstraction levels balancing information preservation against privacy protection, applying more aggressive generalization to entities marked as sensitive while maintaining greater specificity for structural elements essential to reasoning patterns. Type-restricted masking represents the third substep, implementing targeted removal or replacement of sensitive typed entities based on federation policies and regulatory requirements, applying masking operations to categories designated as sensitive including proprietary operational data, personal information subject to privacy regulations, classified or confidential content, trade secrets, and instance-identifying markers, while maintaining trajectory continuity through null representations or generic placeholders that preserve geometric coherence.

Step 430 implements policy evaluation through multi-criteria assessment ensuring that transformed thoughts comply with federation agreements, regulatory requirements, and organizational policies before authorizing transmission to the shared cache space. The evaluation examines whether residual sensitive information remains detectable in transformed representations through adversarial analysis techniques that attempt to reverse-engineer or combine transformed thoughts with other available information to reconstruct protected details, employing information-theoretic measures to quantify information leakage and comparing against acceptable disclosure thresholds defined by privacy policies. Regulatory compliance verification ensures conformance with diverse legal frameworks including data sovereignty requirements mandating that certain information remain within specific jurisdictions, industry-specific regulations such as HIPAA for healthcare or GDPR for European personal data imposing strict handling and transfer constraints, export control restrictions limiting technology transfer to certain countries or organizations, and intellectual property protections governing sharing of patented or trade secret information. The evaluation also assesses whether reciprocity principles are satisfied by verifying that the instance provides knowledge contributions commensurate with its retrieval patterns from the shared cache, preventing exploitation where instances continuously extract value without providing comparable contributions to the collective federation. Data sovereignty constraints are enforced by examining whether thoughts derived from data subject to location-specific storage or processing requirements can be legally shared with instances in other jurisdictions, implementing geographic restrictions and compliance tracking as necessary.

Decision point 435 determines whether transformed thoughts satisfy all policy requirements, branching based on the compliance evaluation outcome. If policy violations are detected, the method follows the no branch back to step 420 through a feedback loop that enables iterative refinement of transformations until compliance is achieved. This feedback path carries specific guidance about which policy requirements were violated and what adjustments are needed, such as applying more aggressive abstraction to particular entity types, additional masking of residual identifying features, or alternative generalization strategies that better preserve privacy while maintaining reasoning capability. The iterative refinement continues until either compliant transformations are achieved allowing the thought to proceed to transmission, or the system determines that the thought cannot be adequately abstracted without destroying its semantic value, in which case it is excluded from federation and marked for local-only use. If transformed thoughts pass policy evaluation, the method proceeds with the yes branch to step 440, continuing the synchronization pipeline with thoughts that have successfully balanced privacy protection against knowledge sharing utility.

Step 440 implements transmission of compliant transformed thoughts to the shared cache space through network protocols optimized for geometric data transfer. The transmission packages each transformed thought T(γ) with comprehensive metadata enabling receiving instances and the shared cache infrastructure to properly interpret, validate, and integrate the federated knowledge. Provenance metadata identifies the originating PCM instance, the timestamp of original thought generation, the domain or operational context where the thought was developed, and the transformation parameters applied during privacy processing, creating a complete audit trail that supports transparency and accountability in federated knowledge sharing. Trust scores computed by the originating instance quantify the reliability and validation status of each thought based on factors such as how many times it has been successfully applied in local reasoning, whether it has been validated through ground truth comparison or expert review, the stability of the thought under perturbation during local dreaming processes, and consistency with established domain knowledge, providing receiving instances with quantitative guidance for assessing the credibility of federated knowledge. Geometric compression information documents the compression algorithms applied, the fidelity levels achieved, and any constraints or assumptions embedded in the compressed representations, enabling receiving instances to properly reconstruct and interpret the transmitted thoughts. The transmission employs bandwidth-efficient encoding schemes that exploit the geometric structure of manifold representations, using techniques such as differential encoding that transmits changes rather than complete representations, manifold-aware compression that identifies and preserves critical topological and curvature features while aggressively compressing less essential details, and adaptive bitrate allocation that assigns more transmission resources to high-priority or high-fidelity components while reducing precision for less critical elements.

Step 450 implements reception and retrieval of thoughts from the shared cache space, enabling the local instance to enhance its capabilities with knowledge developed by other federation participants. The retrieval process begins with query formation where the local instance identifies knowledge gaps, operational challenges, or reasoning requirements that might benefit from collective federation experience, formulating queries that specify semantic requirements, geometric characteristics, and quality thresholds for desired knowledge. The queries leverage the manifold-based indexing and semantic organization within the shared cache space to efficiently discover relevant bundles without exhaustive enumeration, using geometric proximity measures, semantic similarity scores, and metadata filters to rapidly identify promising candidates. Trust score filtering enables the instance to preferentially retrieve knowledge from sources with established credibility and domain expertise, implementing a reputation-based discovery mechanism that prioritizes thoughts with proven cross-instance validation while avoiding untested or low-quality contributions. Access control policies mediate the retrieval process, ensuring that the instance only receives bundles it is authorized to access based on semantic alignment indicating the instance's local manifold can meaningfully accommodate the knowledge, demonstrated competence in relevant domains evidenced by contribution history and successful prior integrations, privacy constraints restricting certain bundles based on source provenance or content sensitivity, and federation agreements defining sharing relationships between instance groups based on organizational affiliations or collaborative arrangements.

Step 460 implements geodesic registration, the sophisticated geometric alignment process that adapts retrieved thoughts from their abstract shared representations into forms compatible with the local instance's specific manifold structure. This critical transformation addresses the fundamental challenge that different PCM instances may have evolved distinct geometric embeddings for similar knowledge domains due to different operational histories, contexts, and learning trajectories, requiring careful mapping to integrate external thoughts in ways that preserve their semantic content and reasoning capability while conforming to local geometric conventions. The registration solves an optimization problem formulated as min_{Φ}∫ₒ¹d²_{M}_{ⱼ}Φ(T(γ(t)), η(t) dt where Φ represents a mapping from the retrieved thought trajectory T(γ(t)) to a trajectory η(t) within the local manifold Mⱼ that minimizes distortion measured by squared geodesic distance integrated over the complete trajectory. The optimization employs sophisticated numerical methods adapted for curved manifolds including Riemannian gradient descent that computes gradients respecting the manifold's metric structure rather than naive Euclidean derivatives, shooting methods that propagate initial conditions forward while satisfying boundary constraints at trajectory endpoints, and iterative relaxation techniques that progressively refine approximate solutions toward true geodesics through energy minimization. The registration process evaluates multiple criteria to assess alignment quality including geometric distortion quantifying how much the mapping Φ deforms the original trajectory, semantic preservation verifying that conceptual relationships and logical dependencies remain intact despite geometric transformation, local coherence ensuring that the aligned trajectory integrates smoothly with neighboring structures in the local manifold without creating discontinuities or anomalies, and computational efficiency determining whether the aligned trajectory can be traversed with reasonable cognitive cost during future reasoning operations.

Decision point 465 evaluates whether geodesic registration achieved successful alignment meeting quality thresholds for geometric fidelity, semantic coherence, and computational tractability. If alignment fails due to excessive distortion, semantic corruption, or geometric incompatibility between the retrieved thought and local manifold structure, the method follows the no branch to step 467 which implements conflict logging and resolution procedures. The conflict logging records detailed information about the alignment failure including the specific retrieved bundle that could not be integrated, quantitative metrics describing the nature and magnitude of alignment difficulties such as distortion measures, semantic mismatch scores, or computational cost estimates, the local manifold region where integration was attempted and why it proved incompatible, and timestamp and context information enabling later analysis of failure patterns. The system may choose to discard the incompatible thought, returning it to the shared cache marked with metadata indicating this instance could not successfully integrate it, flag the thought for manual review where human operators or higher-level coordination mechanisms can assess whether the alignment failure indicates genuine incompatibility or whether adjusted integration strategies might succeed, or attempt alternative alignment approaches such as trying different target regions within the local manifold, applying additional abstraction to the retrieved thought before re-attempting registration, or seeking guidance from the originating instance about proper interpretation and application. After logging and initial response, the method proceeds to step 470 to continue processing other retrieved thoughts that may align more successfully. If alignment succeeds, the method follows the yes branch directly to step 470, proceeding with integration of the successfully aligned thought into local cognitive structures.

Step 470 implements integration of successfully aligned thoughts into the local thought cache, making the federated knowledge available for use in future cognitive operations. The integration process stores the aligned thought representation within the cache organizational structure, determining the appropriate storage tier based on the thought's abstraction level, domain specificity, and expected usage patterns, with high-level abstractions placed in readily accessible locations for frequent retrieval while more specific patterns may be stored in less prominent positions reflecting their narrower applicability. The stored representation includes not just the aligned trajectory but also comprehensive metadata inherited from the original source and augmented during the integration process. Provenance from the source instance is preserved completely, maintaining the chain of custody showing where the knowledge originated, which intermediate instances may have refined or validated it during its journey through the federation, and what transformations were applied at each stage. Trust scores and validation history accompany the thought, providing the local instance with quantitative guidance about the reliability and proven effectiveness of the federated knowledge based on cross-instance validation results, successful applications in diverse contexts, and stability under various perturbations and adaptations. Timestamp and version information enables temporal tracking of when the thought was originally generated, when it was retrieved by this instance, and what version of the shared bundle was integrated, supporting version control during concurrent federation operations and enabling detection of staleness when thoughts have been superseded by more recent refinements in the shared cache.

Step 480 implements metadata updates that record the synchronization event and its outcomes in both local and shared indices, creating comprehensive tracking that supports transparency, accountability, and optimization of future federation operations. The local instance records detailed information about the synchronization cycle including which thoughts were successfully transmitted to the shared cache with their federation scores, transformation parameters, and transmission timestamps, which thoughts were retrieved from the shared cache with their source instances, trust scores, and integration outcomes, and which alignment attempts succeeded or failed with the specific reasons and corrective actions taken. This local history enables analysis of federation patterns to identify which types of thoughts transfer most successfully, which transformation strategies achieve optimal privacy-utility tradeoffs, and which source instances provide the most valuable and compatible knowledge for this instance's operational context. The shared cache indices are updated to reflect the new contributions and retrieval patterns, incrementing usage statistics for retrieved bundles to track their popularity and cross-instance applicability, recording validation feedback when integrated thoughts are successfully applied in reasoning operations providing evidence of their utility, and updating reputation scores for contributing instances based on the reception and integration success of their federated knowledge. These metadata updates create a comprehensive information infrastructure supporting intelligent federation where past patterns guide future decisions about what to share, how to transform it, and where to retrieve supplemental knowledge.

The method continues through continuation point B to step 485 which implements divergence monitoring, the metacognitive governance mechanism that ensures federated instances maintain sufficient coherence for meaningful collaboration while respecting autonomy envelopes that preserve independent identity and operational flexibility. The monitoring computes cross-instance divergence indices that quantify misalignment between this instance and other federation participants at different manifold layers. The mesoscale divergence Dₘₑₛₒ(i,j) measures differences between decision-level manifolds M₂⁽ⁱ⁾ and M₂^{(j)} of instances i and j, capturing how different their doctrinal postures, decision frameworks, and mid-term reasoning patterns have become through independent operation and learning. This divergence can be computed through multiple mechanisms including metric divergence that measures differences in the Riemannian metric tensors defining distance relationships within the decision spaces, spectral divergence comparing the eigenvalue spectra of Laplace-Beltrami operators capturing the intrinsic geometric structure of the manifolds, and trajectory divergence quantifying how differently the instances traverse their respective decision spaces when addressing similar problems. The foundational divergence D_{found}(i,j) measures differences between identity-level manifolds M₃^{(i) and M}₃^{(j)}, capturing more fundamental misalignments in long-term objectives, values, and metacognitive standards that evolve only slowly and anchor each instance's persistent cognitive identity. The computed divergence values are compared against autonomy envelopes ε₁, ε₂, ε₃ defined for each manifold layer, where ε₁ governs acceptable divergence at the fast event-processing level typically set quite high to allow diverse operational contexts, ε₂ governs mesoscale decision-level divergence typically moderate to enable coalition coordination while respecting organizational differences, and ε₃ governs foundational identity-level divergence typically quite restrictive to maintain coherent federation identity.

Decision point 487 evaluates whether computed divergence values remain within acceptable bounds defined by the autonomy envelopes, branching based on this assessment of federation health. If divergence exceeds autonomy envelopes at any level, indicating that instances have drifted sufficiently far apart to threaten effective collaboration or that fundamental incompatibilities have emerged, the method follows the no branch to step 489 which implements corrective actions designed to restore acceptable coherence. Resynchronization represents the first corrective approach, triggering additional synchronization cycles beyond the regular schedule to increase knowledge exchange frequency and accelerate convergence, potentially with adjusted selection criteria that prioritize thoughts addressing the specific divergent domains where misalignment is concentrated. Constraint reinforcement represents the second approach, implementing stronger downward injection from foundational manifolds through the immersion maps ψ₃₂ and ψ₂₁ to ensure that higher-level policies and values exert greater influence on mid-level and event-level processing, pulling the instance back toward alignment with federation norms encoded in the shared foundational understanding. Arbitration represents the most intensive corrective approach, involving human operators, inter-organizational governance bodies, or designated coordinator instances that mediate between divergent participants to negotiate reconciliation, potentially revising federation policies, clarifying ambiguous doctrines, or in extreme cases determining that certain instances should separate into distinct sub-federations with reduced knowledge sharing. After corrective actions are initiated, the method loops back to continue monitoring, giving the corrections time to take effect before re-evaluating divergence. If divergence remains within acceptable envelopes, the method follows the yes branch to step 490, continuing with normal federation maintenance knowing that coherence is adequate for effective collaboration.

Step 490 implements computation and updating of residual functionals that quantify internal coherence within this instance and aggregate federation-wide coherence across all participants. The internal residual Cᵢₙₜₑᵣₙₐₗ for this instance measures tension between upward abstraction and downward constraint as integrated across all points in the fast manifold M₁, capturing how well the instance's event-level processing, decision-level reasoning, and foundational identity remain mutually coherent through the vertical mappings. The federated residual C_{federated} aggregates both internal residuals across all instances and cross-instance divergence terms according to the formula C_{federated}=ΣᵢCᵢ+Σᵢ<ⱼ(Dₘₑₛₒ(i,j)+D_{found}(i,j)), providing a comprehensive scalar measure of overall federation health that combines local coherence and cross-instance alignment into a single optimization target. The residual tracking maintains historical records of how these functionals evolve over time, enabling analysis of coherence trends, identification of instances experiencing increasing internal tension or divergence from peers, and assessment of whether federation mechanisms successfully maintain coordination or whether systematic drift threatens long-term collaboration. The coherence metrics derived from these residuals inform multiple aspects of federation governance including synchronization scheduling where instances with high divergence may be prioritized for knowledge exchange, transformation aggressiveness where instances with low trust relationships may receive more heavily abstracted knowledge to reduce integration difficulties, and strategic planning where persistent coherence challenges may indicate need for policy revision, infrastructure enhancement, or federation restructuring.

Step 495 applies gradient flow correction, the continuous adaptation mechanism that adjusts each instance's foundational trajectory to minimize global residual tension and maintain federation coherence while respecting local autonomy. The correction implements a differential equation dr/dt=−∇_M₃C_{federated}(r) where r represents the current foundational state of the instance within manifold M₃ and ∇_M₃ denotes the Riemannian gradient computed with respect to the foundational manifold's metric structure. This gradient flow naturally evolves the instance's identity and long-term objectives in directions that reduce total federation residual, gently pulling the instance toward greater alignment with collective norms while allowing the natural geometric dynamics of the manifold to determine the specific trajectory. The correction operates at slow timescales appropriate to foundational changes, implementing small adjustments rather than abrupt shifts that would destabilize identity and disrupt ongoing operations. The gradient computation accounts for the curved geometry of the foundational manifold, ensuring that descent follows true geodesic directions rather than naive Euclidean gradients that might violate manifold structure. The correction also respects constraints that preserve essential identity characteristics, implementing projected gradient methods that confine evolution to feasible regions of foundational space where the instance maintains core values and operational requirements that cannot be compromised for federation alignment. The accumulated effect of continuous gradient flow correction over extended periods gradually shapes the federated instances toward configurations that minimize collective tension, creating emergent coordination where autonomous participants naturally evolve toward compatible perspectives without centralized control or loss of independent agency.

Step 498 implements comprehensive logging of the completed synchronization event, creating records that support analysis, debugging, optimization, and accountability in federation operations. The logging captures synchronization metrics quantifying the execution of the synchronization cycle including how many thoughts were selected as federation candidates with their average scores and score distributions, how many passed policy evaluation and were successfully transmitted with their sizes and transmission times, how many thoughts were retrieved from the shared cache with their source instances and trust scores, and how many alignment attempts succeeded or failed with their specific outcomes and corrective actions. Divergence evolution tracking records the divergence indices computed during this cycle and how they compare to previous measurements, enabling trend analysis that identifies whether the federation is maintaining stable coordination, experiencing gradual drift requiring intervention, or successfully converging toward tighter alignment. The logs also capture performance metrics such as computational costs of transformation and alignment operations, network bandwidth consumed and transmission latencies experienced, and processing times for each major step in the synchronization pipeline, providing data for infrastructure optimization and capacity planning. Error and exception information documents any failures, anomalies, or unexpected behaviors encountered during synchronization, preserving diagnostic information that supports troubleshooting and refinement of federation mechanisms.

The method concludes at the end marker but immediately loops back to the start through a continuous monitoring feedback path, implementing the perpetual nature of federation where synchronization occurs repeatedly over the lifetime of the distributed system. This continuous operation ensures that federated instances maintain current knowledge of each other's capabilities and understanding, that new thoughts developed locally are promptly shared for collective benefit, that divergence is detected early before it accumulates to levels threatening effective collaboration, and that the federation adapts continuously to changing operational contexts, evolving domains, and shifting participant composition. The iterative cycle implements a dynamic equilibrium where autonomous instances continuously adjust their knowledge, maintain coordination through shared understanding, and collectively evolve toward more sophisticated reasoning capabilities while preserving the independence and diversity essential for robust distributed cognition. The key insight emphasized at the bottom of the figure notes that this iterative process ensures continuous federation while maintaining coherence and autonomy, achieving the delicate balance between collective intelligence and individual agency that distinguishes federated thought caching from both fully centralized systems that eliminate autonomy and fully independent systems that forego collective learning.

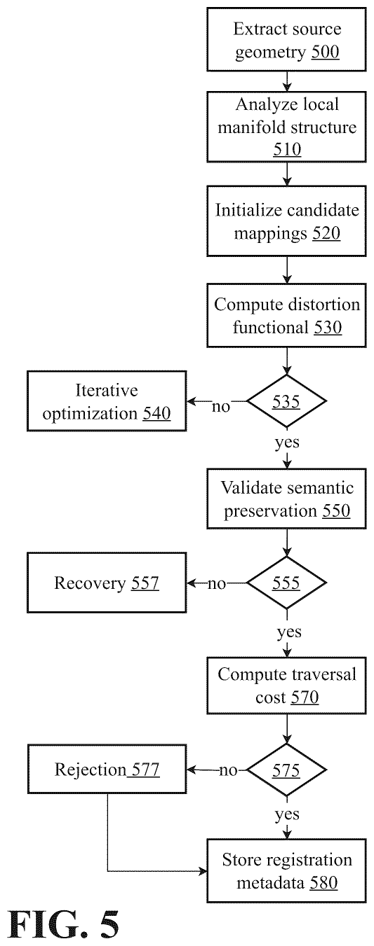

FIG. 5 is a flow diagram illustrating an exemplary method for implementing geodesic registration of received thoughts from the shared cache space into a local PCM instance's manifold structure, demonstrating the sophisticated geometric alignment process that enables cross-instance knowledge transfer while preserving semantic integrity and respecting the unique geometric conventions that each instance has developed through its operational history. Geodesic registration represents the critical transformation mechanism that bridges the gap between abstract federated knowledge representations and concrete local cognitive structures, solving the fundamental challenge that different PCM instances may have evolved distinct geometric embeddings for similar domains due to different experiences, contexts, and learning trajectories. This method implements a multi-stage optimization and validation pipeline that seeks mappings minimizing geometric distortion while maintaining logical relationships, ensuring smooth integration with existing local structures, and achieving acceptable computational efficiency for future cognitive operations utilizing the aligned knowledge.

The method begins at step 500 with extraction of source geometry from the transformed thought T(γ) retrieved from the shared cache space, analyzing the geometric and topological properties that must be preserved or appropriately adapted during alignment to the local manifold. The extraction process identifies trajectory points T(γ(t)) for t∈[0,1] representing the discrete sampling of the continuous thought trajectory through the abstract manifold space, capturing not just positions but also velocity information encoding the direction and rate of semantic transitions between conceptual waypoints. The local curvature profile K_{source}(t) characterizes how the trajectory bends through semantic space at each point, with high curvature regions indicating rapid conceptual transitions or decision points where reasoning changes direction significantly, while low curvature segments represent smooth conceptual progressions following consistent logical flows. Topological features are extracted including connectivity patterns describing how different components of the thought relate to each other, holes or voids in the trajectory's neighborhood indicating conceptual boundaries or exclusions where certain semantic regions are deliberately avoided, handles or bridges connecting previously separate conceptual domains, and genus characteristics describing the fundamental topological structure independent of specific geometric embedding. This comprehensive geometric characterization provides the foundation for all subsequent alignment operations, capturing both the continuous differential geometry and discrete topological structure essential for faithful representation of the thought's semantic content.

Step 510 implements analysis of the local manifold structure where the received thought must be integrated, examining the geometric properties, semantic organization, and existing cognitive structures that constrain how external knowledge can be accommodated. The analysis computes the local metric tensor gj defining distance relationships within the local manifold Mj, capturing how the instance measures semantic similarity and conceptual proximity based on its accumulated experience and learned representations. This metric may differ substantially from the abstract metric used in the shared cache space due to the instance's specialized domain focus, unique operational context, or particular learning history that has shaped its semantic embeddings. The analysis identifies candidate target regions within the local manifold that exhibit semantic compatibility with the received thought, using content analysis to find areas where the local instance maintains knowledge about related domains, geometric analysis to locate regions with compatible curvature profiles and dimensionality, and structural analysis to identify neighborhoods with sufficient capacity to accommodate new knowledge without destabilizing existing cognitive structures. Semantic compatibility assessment examines whether the received thought addresses concepts, procedures, or reasoning patterns that align with knowledge domains where the local instance operates, evaluating conceptual overlap through shared entity types, similar reasoning structures, and compatible operational assumptions. Regions with high semantic compatibility become preferred targets for alignment, as they offer the greatest likelihood of successful integration where the received thought can leverage existing related knowledge and contribute meaningfully to the instance's cognitive capabilities.

Step 520 initializes candidate mappings that provide starting points for the optimization process seeking the best alignment between the received thought and local manifold structure. The initialization generates a preliminary mapping Φ₀ that establishes correspondences between the source trajectory T(γ) and a candidate trajectory η in the local manifold Mⱼ, creating an initial guess that subsequent optimization will refine toward an optimal solution. Endpoint alignment represents the first initialization strategy, matching the start and end points of the source trajectory with semantically equivalent positions in the local manifold based on conceptual similarity, ensuring that the aligned trajectory begins and terminates at locally meaningful locations that provide proper context for the intermediate reasoning steps. Principal curvature direction matching represents the second strategy, aligning the directions of maximum and minimum curvature between source and local representations to ensure that the geometric structure encoding semantic relationships transfers appropriately, preserving the shape characteristics that define how the thought navigates through conceptual space. Waypoint correspondence creation represents the third strategy, identifying key intermediate points along the source trajectory corresponding to significant conceptual transitions or decision points, and establishing mappings to equivalent positions in the local manifold where similar semantic transitions occur. These initialization strategies may be applied individually or in combination, potentially generating multiple candidate initial mappings that are evaluated in parallel to identify which provides the best starting point for optimization. The quality of initialization significantly impacts the efficiency and success of subsequent optimization, with good initial mappings converging rapidly to high-quality alignments while poor initializations may become trapped in local minima representing suboptimal alignments that satisfy mathematical criteria but fail to capture proper semantic correspondence.

Step 530 computes the distortion functional that quantifies the quality of a proposed mapping, providing the objective function that optimization algorithms seek to minimize during the search for optimal alignment. The core distortion measure is formulated as D[Φ]=∫₀¹ d²_{M}_{ⱼ}Φ(T(γ(t)), η(t)) dt, integrating the squared geodesic distance in the local manifold Mj between the mapped source trajectory Φ(T(γ(t))) and the target trajectory η(t) over the complete trajectory duration from t=0 to t=1. This formulation captures how much geometric adjustment is required to transform the abstract source representation into a form compatible with local manifold structure, with lower distortion indicating mappings that preserve the source trajectory's essential shape and semantic relationships while higher distortion suggests that alignment requires substantial deformation potentially compromising semantic integrity. The distortion functional is augmented with regularization terms that encode additional desirable properties beyond simple distance minimization. The curvature preservation penalty adds terms that penalize excessive changes in sectional curvature between source and aligned trajectories, ensuring that the geometric features encoding semantic density and conceptual importance transfer appropriately rather than being distorted beyond recognition during alignment. The smoothness constraint adds terms favoring mappings Φ that vary smoothly across the trajectory, penalizing abrupt changes in mapping behavior that could introduce artifacts or discontinuities in the aligned representation. Additional regularization terms may include energy minimization favoring mappings that minimize total deformation energy analogous to elastic material distortion, topology preservation ensuring that connectivity and handle structures remain intact during alignment, and boundary condition satisfaction when alignment must respect constraints at trajectory endpoints or other fixed points. The weighted combination of these terms creates a comprehensive objective function that captures multiple aspects of alignment quality, enabling optimization algorithms to balance competing objectives and find mappings that achieve satisfactory performance across all criteria.

Decision point 535 evaluates whether the computed distortion falls below an acceptable threshold, determining whether the current mapping provides sufficient quality to proceed with semantic validation or whether further optimization is required. The threshold is not a fixed value but adapts based on factors including the semantic importance of the received thought where high-value knowledge may justify accepting higher distortion to enable integration, the availability of alternative target regions where abundant options allow more stringent quality requirements while limited choices necessitate greater flexibility, computational budget constraints where time-critical operations may accept adequate rather than optimal alignments, and empirical success rates observed in past integration attempts providing data-driven guidance for threshold calibration. If distortion exceeds the threshold, indicating that current mapping quality is inadequate, the method follows the no branch to step 540 which implements iterative optimization seeking improved alignments. If distortion satisfies the threshold, the method proceeds with the yes branch to step 550, continuing to semantic validation with confidence that geometric fidelity meets basic requirements for successful integration.

Step 540 implements optimization of the mapping through sophisticated algorithms adapted for the curved geometry of Riemannian manifolds, iteratively refining the candidate mapping to reduce distortion while maintaining semantic coherence. The optimization employs Riemannian gradient descent that computes gradients respecting the manifold's metric structure rather than naive Euclidean derivatives, following the formula Φₖ₊₁=Φₖ−α∇_{Φ}D[Φₖ] where α represents the step size and ∇_{Φ} denotes the Riemannian gradient operator accounting for manifold curvature. Each optimization iteration involves computing the gradient of the distortion functional with respect to mapping parameters, determining how small changes in the mapping would affect overall distortion and identifying directions in mapping space that most rapidly reduce distortion. The gradient computation itself requires parallel transport along geodesics to maintain geometric consistency when comparing tangent spaces at different manifold locations, ensuring that gradient directions remain meaningful despite the curved geometry. The step size α is adapted dynamically using line search methods that evaluate multiple step sizes along the gradient direction to identify the optimal movement balancing rapid convergence against stability, or trust region methods that constrain updates to regions where local linear approximations remain valid. The optimization continues iteratively, generating a sequence of progressively improved mappings Φ₀, Φ₁, Φ₂, . . . that should converge toward a local minimum of the distortion functional. Convergence criteria terminate the optimization when distortion improvements between successive iterations fall below a threshold indicating that further refinement yields diminishing returns, when the gradient magnitude becomes sufficiently small suggesting proximity to a stationary point, or when maximum iteration limits are reached preventing unbounded computational expenditure. The optimized mapping is then re-evaluated at decision point 535 to determine whether achieved distortion quality warrants proceeding to semantic validation.

Step 550 implements validation of semantic preservation, the critical assessment ensuring that geometric alignment has not corrupted the logical content, causal relationships, or conceptual structure that give the received thought its reasoning value. This validation examines the aligned trajectory Φ(T(γ)) through multiple semantic lenses independent of geometric metrics. Logical dependency checking verifies that if the original thought represented a reasoning chain where conclusions depended on premises, these inferential relationships remain intact in the aligned representation, ensuring that drawing conclusions from the aligned thought produces results consistent with the original reasoning rather than introducing logical errors or invalid inferences. Causal relationship preservation confirms that temporal or causal orderings encoded in the original trajectory maintain their proper sequence in the aligned version, preventing situations where effects appear before causes or where temporal progressions become scrambled through geometric transformations that preserve distance metrics but violate directional constraints. Semantic distance relationship maintenance assesses whether concepts that were close in the original representation remain proximate after alignment and whether distant concepts maintain their separation, verifying that the alignment preserves the overall semantic topology even if specific geometric embeddings change. Key conceptual waypoint recognizability evaluates whether the major decision points, state transitions, or reasoning milestones that structured the original thought remain identifiable in the aligned version, ensuring that humans or higher-level cognitive processes inspecting the aligned thought can recognize its essential structure and interpret its meaning appropriately.

Decision point 555 determines whether semantic validation reveals that essential logical and conceptual content has been preserved through the alignment process. If semantic corruption is detected where the aligned thought has lost critical inferential relationships, scrambled causal orderings, or become conceptually incoherent, the method follows the no branch to step 557 which attempts recovery through alternative alignment strategies. If semantic integrity remains intact despite geometric transformations, the method follows the yes branch to step 560, proceeding to local coherence assessment with confidence that the thought retains its reasoning value.

Step 557 implements an alternative strategy when initial alignment attempts fail to preserve semantic integrity, selecting a different target region within the local manifold Mⱼ where the received thought might integrate more successfully. This step recognizes that alignment failure may indicate not that the thought is inherently incompatible with the local instance but rather that the initial target region selection was suboptimal, perhaps lacking sufficient semantic similarity or possessing geometric characteristics that resist successful alignment. The alternative target selection considers regions that were identified as secondary candidates during the initial analysis in step 510, regions with related but not identical semantic content that might provide better geometric compatibility, or entirely novel regions discovered through broader search if initial candidates prove inadequate. The method then returns to step 520 to initialize new candidate mappings targeting the alternative region, essentially restarting the alignment process with different assumptions about where in the local manifold the received thought should be embedded. This retry mechanism implements robustness against local minima in the optimization landscape and against initial target selection errors, providing multiple opportunities to find successful alignments before concluding that a received thought cannot be integrated.

Step 560 implements assessment of local coherence, evaluating how well the aligned trajectory integrates with surrounding cognitive structures already present in the local manifold. This assessment examines the geometric transition regions where the new aligned thought connects to or passes near existing thought bundles, reasoning patterns, and semantic structures that form the established cognitive landscape. Smoothness at bundle boundaries verifies that the aligned trajectory exhibits continuous transitions where it approaches or enters existing thought bundles, avoiding abrupt discontinuities in curvature, velocity, or semantic content that would create awkward transitions requiring excessive cognitive effort to traverse. Curvature continuity with neighbors confirms that the local curvature of the aligned trajectory matches appropriately with the curvature of surrounding manifold regions, ensuring that the semantic density relationships implied by curvature remain consistent across the integration boundary rather than creating artificial compression or expansion effects. Geometric singularity detection identifies whether the alignment process has inadvertently created pathological geometric features such as infinite curvature points, metric degeneration where distance measurements break down, or topological defects where manifold structure becomes ill-defined, any of which would compromise the usability of the aligned thought and potentially destabilize surrounding cognitive structures Decision point 565 determines whether local coherence assessment reveals acceptable integration quality or whether geometric artifacts require correction before the aligned thought can be safely incorporated into the local cache. If coherence issues are detected such as rough transitions, curvature mismatches, or nascent singularities, the method follows the no branch to step 567 which applies corrective smoothing operations. If local coherence is satisfactory with the aligned thought integrating cleanly into surrounding structures, the method follows the yes branch to step 570, proceeding to computational cost assessment.

Step 567 implements corrective operations addressing local coherence issues through geometric refinement of transition regions and adjustment of local metric structure. Smoothing operations apply diffusion processes or regularization filters to transition regions where the aligned trajectory connects to existing structures, gradually blending geometric properties across boundaries to eliminate abrupt discontinuities while preserving the essential character of both the new aligned thought and the existing local structures it adjoins. Local metric adjustment modifies the metric tensor gⱼ in small neighborhoods around integration points, subtly reshaping distance relationships to accommodate the new thought without requiring drastic modifications to either the aligned trajectory or existing structures, implementing a form of geometric accommodation where the local manifold adapts slightly to welcome the new knowledge. These corrections are applied conservatively, making minimal modifications necessary to achieve acceptable coherence while avoiding excessive manipulation that could destabilize the carefully evolved geometric structure representing the instance's accumulated knowledge. After corrections are applied, the method returns to decision point 565 to re-evaluate whether coherence now meets requirements, potentially iterating if initial corrections prove insufficient.

Step 570 implements computation of traversal cost, the practical assessment of how much cognitive effort will be required to utilize the aligned thought during future reasoning operations. This cost analysis goes beyond abstract geometric quality metrics to evaluate the computational and cognitive implications of incorporating this knowledge into active processing. Integration with compression pressure examines how the aligned thought interacts with the compression pressure field P(x)=−R(x) derived from local Ricci curvature, determining whether the thought lies in high-pressure regions requiring substantial cognitive effort to traverse or in lower-pressure corridors enabling efficient reasoning flows. Expected retrieval efficiency estimates how quickly and reliably the aligned thought can be located and activated when needed, based on its geometric position relative to frequently accessed regions, its integration with existing indexing structures, and the clarity of semantic pathways leading to it from common reasoning starting points. Adaptation overhead for application assesses whether utilizing the aligned thought will require significant on-the-fly geometric transformations or parameter adjustments during reasoning operations, or whether it can be applied relatively directly once retrieved, with lower adaptation overhead indicating more immediately useful knowledge.

Decision point 575 evaluates whether the computed traversal cost falls within acceptable bounds for practical utilization of the aligned knowledge. If the cost exceeds thresholds indicating that the aligned thought would be computationally prohibitive or cognitively inefficient to use despite successful geometric alignment and semantic preservation, the method follows the no branch to step 577 which rejects the alignment as impractical. If traversal cost is acceptable indicating that the aligned thought represents truly usable knowledge that the instance can efficiently apply during future reasoning, the method follows the yes branch to step 580, proceeding to store registration metadata and complete the successful integration.

Step 577 implements rejection of alignments that satisfy geometric and semantic criteria but fail practical utility requirements due to excessive traversal cost. This rejection represents a pragmatic recognition that not all mathematically valid alignments produce actually useful knowledge transfers, acknowledging that some external thoughts may be so incompatible with local manifold structure that achieving even adequate alignment requires placing them in awkward geometric positions that would be inefficient or impractical to utilize. The rejection process logs detailed information about why the alignment was deemed impractical including specific cost metrics that exceeded thresholds, the geometric characteristics that contributed to high cost such as placement in high-pressure regions or poor connectivity to frequently accessed areas, and assessment of whether the cost issues are fundamental to this thought or might be addressed through future manifold reorganization during dreaming processes. The logged information may inform future decisions about whether to retry integration after local manifold structure evolves, whether to request alternative abstractions of the same knowledge from the originating instance, or whether to simply acknowledge that this particular thought does not transfer effectively to this instance despite proving valuable elsewhere in the federation. After rejection and logging, the method proceeds to conclusion acknowledging that while alignment was attempted and passed multiple quality gates, practical considerations prevented successful integration.

Step 580 implements storage of comprehensive registration metadata that documents the successful alignment process and provides information essential for future utilization and maintenance of the integrated knowledge. The stored metadata includes the complete mapping parameters Φ that define the transformation between the abstract shared representation and the concrete local embedding, enabling potential reconstruction or re-evaluation of the alignment if needed during future manifold maintenance or debugging. Distortion metrics achieved during registration are recorded including the final distortion functional value, convergence history showing how distortion was reduced during optimization, and breakdowns of distortion contributions from different trajectory segments or optimization objectives, providing quantitative evidence of alignment quality that can inform trust assessments and validation decisions. Source provenance and trust score information inherited from the shared cache is preserved completely, maintaining the chain of custody showing where the knowledge originated, what transformations were applied during privacy processing and federation, what validation the thought received in other instances or in the shared cache, and what reputation scores were assigned based on prior successful applications. This comprehensive metadata accompanies the aligned thought throughout its lifecycle in the local cache, supporting informed decisions about when to apply it, how much confidence to place in its guidance, and when it might warrant re-evaluation or replacement as the federation continues to evolve and refine its collective knowledge.

The method concludes at the success endpoint with registration successfully completed, indicating that the received thought from the shared cache has been geometrically aligned to local manifold structure, validated for semantic preservation and local coherence, assessed for practical utility, and stored with comprehensive metadata enabling its effective utilization in future cognitive operations. The successful completion represents a complete knowledge transfer cycle where abstract federated knowledge has been transformed into concrete local cognitive capability, enriching the instance's reasoning resources with patterns, procedures, or insights developed by other federation participants while maintaining geometric consistency with local cognitive structures and preserving the semantic integrity that makes the knowledge valuable. The key insight emphasized notes that geodesic registration enables cross-instance knowledge transfer while respecting geometric constraints and preserving semantic integrity, highlighting this process as the essential mechanism bridging the gap between collective federated intelligence and individual autonomous instances operating with distinct evolved geometric structures.

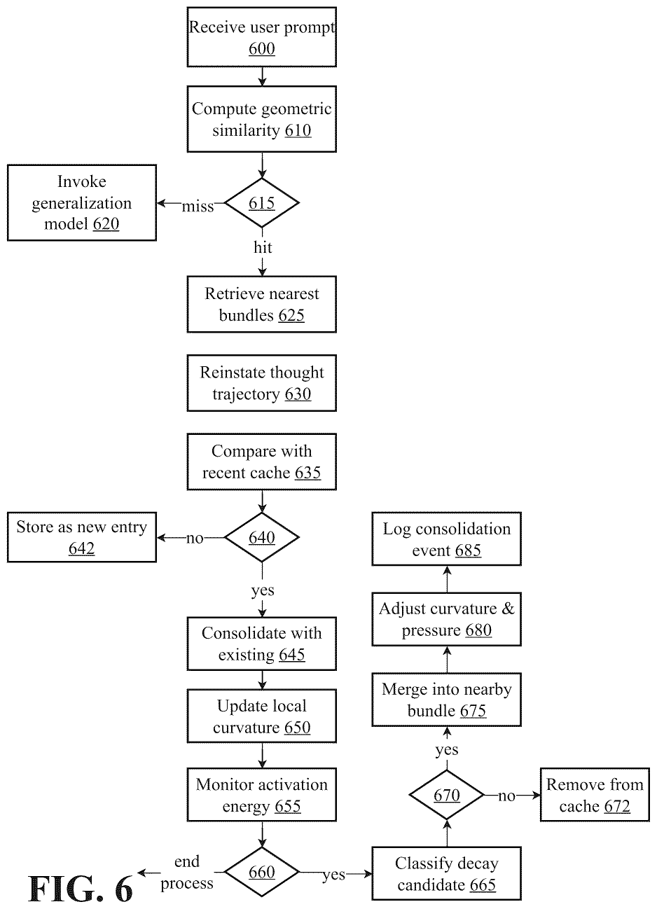

FIG. 6 is a flow diagram illustrating an exemplary method for implementing distributed thought caching with geometric similarity matching and progressive consolidation within a latent manifold, demonstrating the complete cognitive processing cycle from query reception through cache lookup, response generation, consolidation decisions, and thermodynamic decay management that together enable logarithmic scaling of memory requirements despite linear growth in processed experiences. This method implements the core mechanisms through which the Persistent Cognitive Machine achieves efficient persistent memory by continuously organizing cached thoughts into progressively more abstract and consolidated structures, naturally forgetting obsolete information through energy decay while preserving frequently accessed knowledge through reinforcement, and maintaining optimal geometric organization of the manifold to facilitate rapid retrieval and efficient reasoning. The method operates continuously throughout the PCM's operational lifetime, processing each user interaction through cache-aware pathways that leverage accumulated experience while simultaneously contributing to the ongoing evolution and refinement of the cached knowledge base.

The method begins at step 600 with reception of a user prompt that initiates a cognitive processing cycle, encoding the prompt into a latent query trajectory Y_{query}(t) within the manifold that captures both the explicit content and implicit semantic relationships of the user's request. The encoding process transforms natural language or multimodal input into a geometric representation existing as a structured trajectory through the high-dimensional latent space, where the path through semantic regions reflects the conceptual content of the query, the curvature along the trajectory indicates semantic density and conceptual complexity, and the endpoints define the semantic boundaries of the request. This query trajectory serves as the basis for all subsequent cache lookup operations, providing a geometric signature that can be compared against cached thoughts to identify relevant prior experiences that might address the current request without requiring complete recomputation.

Step 610 implements computation of geometric similarity between the query trajectory and all cached thought trajectories, employing multiple complementary measures that collectively assess whether cached knowledge can satisfy the current query. Geodesic distance d_{geo}(γ_{query}, γᵢ) represents the fundamental similarity metric, measuring the minimal path length through the manifold between the query trajectory and each cached trajectory γᵢ, where smaller distances indicate greater semantic similarity and higher likelihood that the cached thought addresses concerns related to the current query. This distance computation respects the manifold's curved geometry, following geodesic paths rather than naive Euclidean distances to properly account for the semantic structure encoded in local curvature and metric tensor variations. Curvature pattern matching ρₒᵤᵣᵥ compares the curvature profiles along trajectories to identify thoughts with similar reasoning structures, recognizing that trajectories following analogous patterns of semantic transitions may represent transferable reasoning approaches even if their specific content differs, with high curvature correspondence suggesting that cached thoughts navigate similar conceptual terrain through comparable decision sequences. Basin proximity measures the distance from the query trajectory to memory basins, which are regions of high local curvature exhibiting geodesic convergence that serve as attractors for memory reentry, where queries landing within or near a basin naturally gravitate toward the associated cached thoughts through the manifold's geometric structure. Trajectory compatibility score S_{compat} aggregates multiple factors including endpoint alignment assessing whether query and cached trajectories address similar conceptual domains, directional consistency evaluating whether trajectories follow compatible semantic flows, and structural similarity comparing topological features such as branching patterns or cyclic structures that might indicate analogous reasoning architectures.

Decision point 615 evaluates whether geometric similarity measures identify a cache hit where at least one cached thought sufficiently matches the query to warrant retrieval and adaptation rather than generating an entirely new response. The determination employs a composite threshold ε that may incorporate multiple similarity metrics weighted according to their relative importance and reliability, with the threshold adapting based on factors such as cache saturation where abundant cached knowledge allows more stringent matching requirements while sparse caches necessitate accepting more approximate matches, query specificity where precise technical queries demand tighter matching than general conceptual questions, and computational budget where time-critical responses may accept adequate matches while less urgent queries can afford to wait for optimal alignment or new generation. If no cached thoughts achieve similarity scores exceeding the threshold, indicating that the query addresses novel territory not covered by accumulated experience, the method follows the no branch to step 620 which invokes generalization models to synthesize new knowledge. If sufficient similarity is detected, the method follows the yes branch to step 625, proceeding to retrieve and adapt the matching cached thoughts to address the current query.

Step 620 implements invocation of generalization models that synthesize compressed latent thoughts when cache misses occur, generating new cognitive content designed from inception to be cacheable and reusable across future queries. The generalization model operates not as a simple inference engine but as a sophisticated abstraction mechanism that identifies and encodes reusable reasoning patterns suitable for long-term storage and broad application. The synthesis process extracts abstract reasoning patterns from the query context and the generalization model's processing, identifying the core logical structures, decision frameworks, and semantic relationships that characterize the reasoning approach rather than merely capturing specific conclusions or instance-level details. Trajectory compression for caching applies geometric algorithms that reduce the dimensionality and complexity of generated thoughts while preserving essential semantic structure, using techniques such as principal geodesic analysis to identify directions of maximum semantic variation that must be retained, topological simplification to reduce unnecessary geometric complexity while maintaining critical features such as branching points and cyclic structures, and curvature-aware sampling that preserves high-curvature regions encoding important conceptual transitions while aggressively simplifying low-curvature segments representing straightforward progressions. Design for reusability ensures that synthesized thoughts incorporate parameterizable components that can be instantiated differently for varying contexts, maintain abstract representations that generalize beyond the specific query, and encode reasoning structures that transfer across related problem domains. The newly generated thought then proceeds back to the main flow for comparison with recent cache entries and potential consolidation with existing knowledge.

Step 625 implements retrieval of nearest bundles when cache hits occur, accessing the locally stored thoughts that geometric similarity matching identified as relevant to the current query. The retrieval process extracts the best matching thought bundle or bundles based on the similarity scores computed in step 610, prioritizing thoughts with highest geometric proximity, strongest curvature correspondence, and greatest trajectory compatibility with the query. Retrieved bundles include not just individual thought trajectories but entire semantic neighborhoods comprising the thought bundle's internal structure with related sub-concepts and reasoning variations, associated trajectories γ_{cached} representing both the canonical reasoning path and alternative variations that have proven useful in different contexts, and comprehensive metadata that provides essential context for proper interpretation and application. Provenance metadata identifies where each cached thought originated, whether generated locally or retrieved from federation partners, what transformations were applied during privacy processing if the thought came from external sources, and what validation the thought has received through successful application in prior reasoning operations. Trust scores quantify the reliability and proven effectiveness of retrieved thoughts based on factors such as how many times they have been successfully applied, whether they have been validated through ground truth comparison or expert review, their stability under perturbation and variation, and consistency with established domain knowledge and other cached thoughts. This rich metadata enables the instance to make informed decisions about how much confidence to place in cached knowledge and how to appropriately adapt it for the current context.

Step 630 implements reinstatement of thought trajectories, the sophisticated adaptation process that takes cached thoughts and modifies them to address the specific context and requirements of the current query rather than simply replaying fixed responses. Reinstatement recognizes that due to compression, manifold evolution, and contextual differences, cached trajectories cannot simply be replayed verbatim but must be reconstructed in a manner that respects current manifold geometry, goal configurations, and query specifics. Geometric transformations adapt the cached trajectory to align with current manifold structure, which may have evolved since the thought was originally cached through learning, consolidation, or other geometric modifications, applying mappings that preserve semantic content while conforming to current geometric conventions. Adjustment for current goal potentials modifies the trajectory to account for the specific objectives and constraints active in the current reasoning context, which may differ from those present when the cached thought was generated, ensuring that reinstated reasoning remains properly directed toward current goals rather than pursuing objectives that were relevant in past contexts but no longer apply. Semantic structure preservation maintains the essential logical relationships, causal orderings, and conceptual dependencies that give the cached thought its reasoning value, ensuring that adaptation does not corrupt the fundamental cognitive content even as surface representations change to accommodate current context. Response generation from the reinstated path produces output based on the adapted trajectory, leveraging the cached reasoning structure while incorporating current context, potentially achieving dramatically faster response times compared to complete recomputation since the major reasoning work was performed and cached during prior operations.

Step 635 implements comparison with recent cache entries to detect redundancy or opportunities for consolidation, examining whether the newly generated or reinstated thought exhibits significant overlap with existing cached content that would warrant merger rather than independent storage. This comparison focuses on recent entries recognizing that newly generated thoughts are most likely to resemble recent cognitive activity addressing similar domains or problems, implementing a recency-biased search strategy that examines thoughts cached within a sliding time window or within a neighborhood of recently active manifold regions. Geodesic proximity to recent entries measures geometric distance between the new thought and recently cached thoughts, using the same similarity metrics employed during cache lookup but applying them specifically to recent cache population to identify close neighbors that might represent redundant or highly similar reasoning patterns. Semantic overlap assessment examines the conceptual content and logical structure of thoughts beyond pure geometric measures, determining whether thoughts address the same problems, employ similar reasoning strategies, or reach comparable conclusions despite potentially differing in surface representation. Compression potential evaluation analyzes whether merging the new thought with existing entries would reduce overall cache storage requirements while preserving essential information, considering whether the thoughts contain complementary information that could be integrated into a single more comprehensive representation, or whether one thought is effectively a special case or elaboration of another that could be absorbed without loss.

Decision point 640 determines whether detected overlap exceeds threshold θ warranting consolidation rather than independent storage, balancing the benefits of merger including reduced storage requirements, improved generalization through synthesis of multiple instances, and simplified cache organization against the risks of losing unique information or creating overly abstract representations that sacrifice useful specificity. The threshold θ adapts based on cache capacity where approaching storage limits favors aggressive consolidation while abundant capacity permits retaining more independent thoughts, semantic similarity where highly similar thoughts readily consolidate while maintaining distinct representations for thoughts with only modest overlap, and learning phase where early operational periods favor rapid consolidation to establish general patterns while mature systems with stable knowledge bases may preserve more specialized variations. If overlap falls below threshold, indicating that the new thought provides sufficiently distinct value to warrant independent storage, the method follows the no branch to step 642 which stores the thought as a new cache entry. If overlap exceeds threshold, indicating consolidation is appropriate, the method follows the yes branch to step 645 to merge the new thought with existing structures.

Step 642 implements storage of new thoughts as independent cache entries when consolidation is not warranted, positioning them within the manifold based on their geometric properties and semantic relationships to create an organized cache structure that facilitates future retrieval. The storage process determines appropriate manifold coordinates for the new thought based on its semantic content, ensuring it resides in regions where related concepts cluster and where its geometric properties align with local manifold structure, using the thought's curvature profile, topological features, and semantic vectors to identify optimal embedding locations. The positioning considers existing thought bundles in the neighborhood, placing new thoughts sufficiently close to leverage semantic similarity but maintaining adequate separation to preserve distinctness, potentially creating new sparse regions in the manifold when thoughts address genuinely novel conceptual territories not covered by existing cache contents. Metadata initialization accompanies storage, recording initial activation energy levels, provenance information, generation timestamps, and semantic tags that support efficient future retrieval. The new entry is indexed according to multiple schemes including geometric indices organizing thoughts by manifold position to support proximity-based lookup, semantic indices cataloging thoughts by conceptual content to enable content-based retrieval, and temporal indices tracking when thoughts entered the cache to support recency-biased operations.

Step 645 implements consolidation with existing cache entries when overlap is sufficient to warrant merger, applying geometric merging algorithms that combine thoughts while preserving their essential semantic content and reasoning structures. Curvature-weighted averaging represents the primary consolidation technique, computing weighted combinations of geometric representations where weights reflect local curvature, with high-curvature regions receiving greater weight recognition that these regions encode important semantic features while low-curvature segments contribute less distinctive information that can be averaged more aggressively. The averaging produces a merged representation that captures the geometric center of the constituent thoughts in a manner respecting manifold curvature, creating a consolidated thought that represents the common pattern underlying multiple similar instances. Trajectory folding compresses similar paths into canonical representations, identifying recurring trajectory segments that appear across multiple cached thoughts and replacing them with single unified representations that capture the essential reasoning structure while eliminating redundant storage of near-identical paths, particularly effective for consolidating procedural knowledge where multiple experiences follow the same basic diagnostic logic or problem-solving approach with only minor variations. Bundle expansion incorporates new thoughts into existing bundles when semantic proximity is high, adjusting bundle boundaries to encompass the new member, updating internal bundle structure to accommodate the additional content while maintaining navigability, and potentially creating sub-bundles or hierarchical organization when incorporated thoughts introduce meaningful variations worth preserving. Metadata updates reflect the consolidation event, recording which thoughts were merged, what averaging weights or consolidation parameters were applied, and what information may have been generalized or lost, enabling future analysis of consolidation decisions and potential reversal if subsequent operations reveal that consolidation was inappropriate.

Step 650 implements updates to local manifold curvature reflecting cache modifications, ensuring that the geometric structure of the latent manifold evolves appropriately as thoughts are added, consolidated, or removed to maintain a geometric organization that facilitates efficient cognitive operations. Adjustment of the metric tensor in affected regions modifies the local geometry surrounding modified cache entries, potentially contracting distances between thoughts that have been found to relate closely through consolidation or expanding regions where new independent thoughts introduce novel content requiring spatial accommodation. Deepening of attractor basins for frequently accessed regions increases local curvature around thoughts that see repeated use, creating stronger geometric gradients that naturally draw attention toward these valuable knowledge structures during future reasoning operations, implementing a form of geometric reinforcement where the manifold itself evolves to reflect usage patterns and facilitate efficient access to important knowledge. Maintenance of smooth transitions ensures that curvature modifications do not introduce geometric anomalies such as discontinuities in the metric tensor, cusps or singularities in the curvature profile, or abrupt changes in sectional curvature that would impede smooth geodesic traversal during reasoning operations. Propagation of geometric changes extends curvature modifications beyond immediate affected regions to ensure global consistency, using diffusion processes that gradually blend local geometric modifications with surrounding manifold structure, implementing constrained optimization that adjusts geometry to accommodate local changes while minimizing disturbance to established structures, and maintaining topological invariants that preserve essential connectivity and handle structures characterizing the manifold's fundamental organization.

The method continues through continuation points to step 655 which implements monitoring of activation energy for all cached thoughts, tracking the thermodynamic state that determines which thoughts remain viable for retrieval versus which should be consolidated or removed. The monitoring implements a thermodynamic model where each thought maintains activation energy Ei that evolves according to the decay equation dEᵢ/dt=−λAᵢ(t)Eᵢ(t), where λ represents the decay constant and Aᵢ(t) reflects inactivity with Aᵢ=0 during active use and Aᵢ=1 during idle periods. Updates based on access frequency apply energy boosts whenever thoughts are retrieved and successfully used in reasoning operations, with boost magnitudes reflecting the quality and importance of the cognitive contribution, implementing reinforcement where valuable thoughts that repeatedly prove useful maintain high activation energy and resist decay. Boosts for successful retrievals provide stronger reinforcement than simple access, recognizing that retrieval alone doesn't validate a thought's value while successful application in reasoning that produces good outcomes demonstrates genuine utility. Application of thermodynamic decay continuously reduces energy for thoughts that remain unused, implementing natural forgetting that prevents the cache from becoming cluttered with obsolete or rarely applicable knowledge, with decay rates potentially varying based on thought characteristics such as abstraction level where high-level generalizations may decay more slowly than specific instances, domain importance where critical knowledge resists decay while peripheral information fades more rapidly, and structural role where thoughts connecting otherwise disparate regions may be preserved despite lower access frequency due to their architectural importance in maintaining manifold coherence.

Decision point 660 evaluates whether any cached thoughts have activation energy falling below minimum threshold Eₘᵢₙ, identifying candidates for consolidation or removal to maintain cache efficiency. The threshold Eₘᵢₙ represents the minimum energy level at which thoughts justify the storage overhead and geometric complexity they contribute to the cache, with thoughts below this level no longer pulling their weight in the cognitive economy. If all cached thoughts maintain adequate energy levels, the method follows the no branch indicating that the cache population remains healthy with all entries contributing sufficiently to warrant retention, proceeding to completion of the current processing cycle. If any thoughts fall below threshold, indicating that decay has reduced their viability, the method follows the yes branch to step 665 which classifies the decay candidates to determine appropriate handling.

Step 665 implements classification of low-energy thoughts as either compressible candidates that retain value but can be merged with active bundles or prunable candidates that no longer provide sufficient unique value to justify retention in any form. The classification evaluates geometric proximity to nearest active bundle measuring geodesic distance from the decay candidate to the closest thought bundle with high activation energy, where small distances suggest the candidate's information is already well-represented in the active bundle and consolidation can proceed without significant information loss. Semantic overlap with active thoughts assesses conceptual similarity between the candidate and active cache contents through content analysis examining shared entities, common reasoning structures, and comparable conclusions, with high overlap indicating redundancy while low overlap suggests the candidate may contain unique information worth preserving through consolidation or retention. Unique information content quantifies what the candidate contributes beyond what active thoughts already provide, using information-theoretic measures to assess the marginal value of retaining the candidate versus allowing it to decay, considering whether the candidate addresses edge cases not covered by active thoughts, employs alternative reasoning approaches that provide valuable cognitive diversity, or contains historical context that enriches understanding even if not frequently accessed. The classification decision determines whether the thought's information can be meaningfully absorbed into an existing active bundle through geometric interpolation and metadata inheritance, categorizing it as compressible, or whether the thought is genuinely obsolete with no unique value justifying even the minimal overhead of consolidation, marking it as prunable.

Decision point 670 determines which handling path the classified decay candidate should follow based on the compressibility assessment. If the thought is classified as not compressible, indicating it is genuinely obsolete or redundant without unique information worth preserving, the method follows the no branch to step 672 which removes it from the cache. If the thought is classified as compressible, indicating its information can be meaningfully consolidated with active bundles, the method follows the yes branch to step 675 to merge it into a nearby bundle.

Step 672 implements removal of prunable thoughts from the cache, the final stage of thermodynamic decay where thoughts that no longer contribute value are eliminated to free storage resources and simplify manifold structure. The removal process carefully extracts the obsolete thought from the cache organizational structures, removing it from geometric indices that organize thoughts by manifold position, semantic indices that catalog thoughts by content, temporal indices tracking cache history, and any cross-references from other cached thoughts or metadata that might point to the removed entry. Flagging of the affected region for curvature smoothing identifies manifold areas where thought removal may have created geometric discontinuities or irregular curvature patterns that require correction, marking these regions for attention during subsequent manifold maintenance operations that will restore smooth geometry. Logging of the removal event creates a historical record documenting which thought was removed, when removal occurred, what decay trajectory led to the decision, and what information may have been lost, supporting analysis of decay patterns, potential recovery if removal proves premature, and optimization of decay parameters to achieve appropriate balance between aggressive pruning maintaining cache efficiency and conservative retention preserving potentially valuable knowledge.

Step 675 implements merging of compressible thoughts into nearby bundles, the consolidation operation that preserves valuable information from decaying thoughts by integrating them into active structures maintaining high energy. Geometric interpolation computes weighted combinations of the decay candidate and target bundle representations, using interpolation parameters that favor the active bundle's geometry while incorporating distinctive features from the candidate that provide marginal value, creating a merged representation that captures the essential contribution of the candidate without requiring independent storage. Update of bundle metadata records the absorption event, documenting which thought was consolidated, when consolidation occurred, and what information was integrated, maintaining a historical record that supports understanding how the bundle's content has evolved through successive consolidations. Preservation of essential distinctions ensures that consolidation does not eliminate important variations or edge cases represented by the candidate, potentially maintaining internal bundle structure that encodes the fact that multiple similar thoughts contributed to the consolidated representation, enabling future expansion back into separate thoughts if usage patterns reveal that the consolidated form loses important specificity. Expansion of bundle boundaries adjusts the geometric extent of the bundle to encompass the absorbed thought, modifying the bundle's manifold footprint to cover the additional semantic territory introduced by consolidation while maintaining coherent internal structure.

Step 680 implements adjustment of curvature and pressure fields to maintain geodesic continuity after consolidation or removal events that modify manifold structure. Smoothing of the local Ricci tensor applies geometric operations that eliminate discontinuities or irregularities in curvature introduced by structural modifications, using techniques such as Ricci flow that naturally evolves curvature toward smoother configurations, heat equation methods that diffuse curvature anomalies, and constrained optimization that adjusts curvature to satisfy smoothness requirements while preserving essential geometric features. Recalculation of compression pressure P(x) updates the pressure field derived from curvature to reflect the modified manifold structure, ensuring that compression pressure accurately represents current semantic density and appropriately influences future geodesic path computations and attention flow. Assurance of smooth transitions verifies that consolidation or removal has not created geometric artifacts such as cusps, corners, or discontinuities that would impede reasoning operations, validating that geodesics can traverse modified regions without encountering singularities or unstable numerical behavior. Update of attention flow field adjusts the attention vector field A(x,t) to account for modified curvature and pressure, ensuring that attention dynamics properly reflect current manifold structure and guide cognitive processes along paths that remain efficient and semantically coherent despite structural changes.

Step 685 implements logging of consolidation events, creating comprehensive records that support analysis, debugging, and optimization of the progressive consolidation mechanisms enabling logarithmic scaling. Recording of decay trajectory and decision rationale documents the complete history of how thoughts progressed from initial high energy through gradual decay to eventual consolidation or removal, capturing the access patterns, reinforcement events, and decay intervals that characterized each thought's lifecycle, providing data for understanding which types of thoughts maintain value over time versus which become obsolete. Documentation of consolidation or pruning actions taken records the specific handling applied to each decay candidate, whether merged into a bundle with details of the target bundle and interpolation parameters, removed from cache with information about what unique content was lost, or retained despite low energy due to special circumstances such as structural importance or pending re-evaluation, creating an audit trail enabling post-hoc analysis of whether consolidation decisions proved appropriate. This logging data feeds into learning algorithms that continuously refine decay parameters, consolidation thresholds, and energy boost policies to optimize the balance between cache efficiency and knowledge preservation based on empirical observation of which cached thoughts prove valuable over extended operation.

The method converges through continuation point C and concludes, having completed a full cycle of cognitive processing from query reception through cache lookup, response generation, redundancy detection, consolidation decisions, and decay management. The endpoint represents not final termination but rather completion of one iteration in the continuous operation of the distributed thought cache, with the method immediately looping back to await the next user prompt that will initiate another processing cycle. This continuous operation enables the PCM to accumulate experience over extended operation, progressively consolidating similar thoughts into increasingly abstract and general representations, naturally forgetting obsolete information through thermodynamic decay while reinforcing frequently accessed knowledge, and maintaining optimal manifold geometry through continuous curvature updates reflecting usage patterns.

The key insight emphasized highlights that logarithmic scaling is achieved through progressive consolidation where new experiences are absorbed into existing attractor basins rather than requiring proportional storage expansion. This fundamental property distinguishes distributed thought caching from traditional memory systems that exhibit linear or super-linear growth, enabling sustainable long-term operation where memory requirements grow only logarithmically as B(N)~κ log(1+N) despite processing N experiences. The logarithmic scaling emerges naturally from the geometric dynamics of the manifold where frequently accessed regions develop high curvature creating strong attractor basins that capture semantically similar new thoughts, consolidation operations continuously merge similar thoughts reducing cache population, and abstraction processes progressively elevate specific patterns to more general representations applicable across broader contexts. This creates a virtuous cycle where accumulated experience makes the cache more efficient rather than less manageable, with mature systems processing new experiences faster and with less storage overhead than nascent systems because established attractor basins and generalized representations provide frameworks into which new thoughts naturally integrate.

### Exemplary Computing Environment

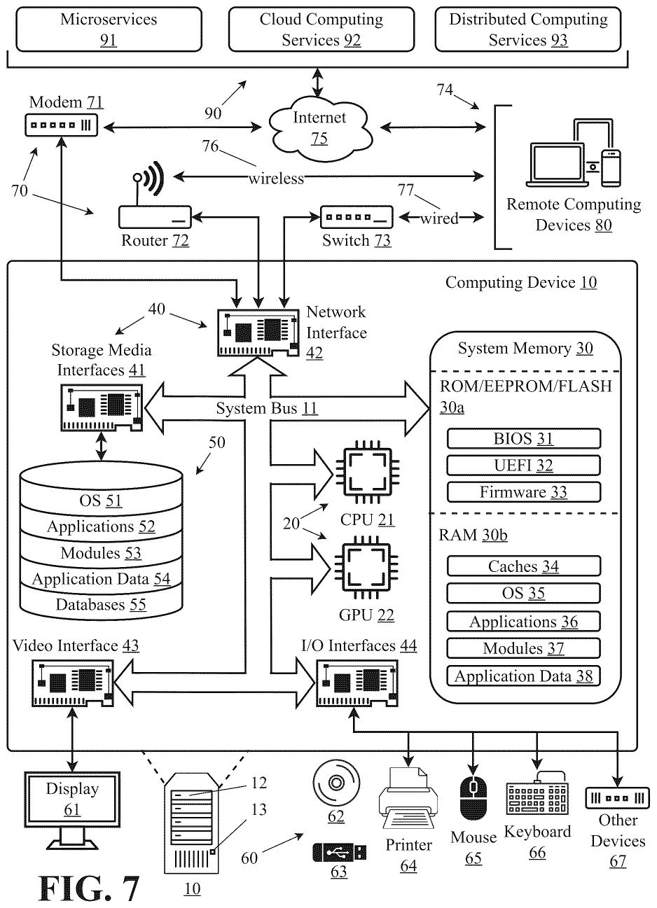

FIG. 7 illustrates an exemplary computing environment (also referred to herein as a computing system) on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Gitlab, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory and one or more processors, wherein the computer system is configured to execute software instructions stored on nontransitory machine-readable storage media that:
maintain a latent manifold as a geometric substrate for cognitive operations, wherein local curvature reflects semantic density;
implement a distributed thought cache comprising a local thought cache storing instance-specific thought trajectories and a shared cache space containing generalized thoughts for cross-instance sharing;
encode inputs into latent query trajectories and determine cache hits based on geometric similarity to cached thoughts;
upon cache hits, retrieve and adapt cached thought trajectories to current context;
upon cache misses, synthesize new compressed thoughts for caching;
apply privacy-preserving geometric transformations to thoughts selected for federation;
synchronize transformed thoughts across distributed instances through federated interfaces;
align received thoughts from the shared cache to local manifold geometry through geodesic registration; and
manage cached thoughts through activation energy monitoring, consolidating low-energy thoughts into active bundles and updating manifold curvature to reflect usage patterns.

2. The computer system of claim 1, wherein the latent manifold comprises a hierarchical structure with a fast manifold representing event-level cognition, a mesoscale manifold representing decision-level cognition, and a foundational manifold representing identity and long-term objectives.

3. The computer system of claim 2, wherein the software instructions further implement upward abstraction mappings as Riemannian submersions preserving local geodesic structure and downward constraint injection mappings as immersions defining allowable submanifolds.

4. The computer system of claim 1, wherein determining cache hits comprises computing geodesic distance, curvature pattern matching, basin proximity, and trajectory compatibility scores between query trajectories and cached thoughts.

5. The computer system of claim 1, wherein the privacy-preserving geometric transformations comprise curvature-preserving deformations maintaining sectional curvature within tolerance, semantic generalization mapping specific entities to categorical abstractions, and type-restricted masking removing sensitive information while preserving trajectory continuity.

6. The computer system of claim 1, wherein geodesic registration comprises solving an optimization problem that minimizes distortion between received thoughts and local manifold structure while preserving semantic structure through geometric transformations.

7. The computer system of claim 1, wherein managing cached thoughts comprises applying thermodynamic decay where activation energy decreases over time for unused thoughts and increases for successfully retrieved thoughts.

8. The computer system of claim 1, wherein consolidating low-energy thoughts comprises geometric merging operations including curvature-weighted averaging, trajectory folding compressing similar paths, and bundle expansion incorporating thoughts into existing structures.

9. The computer system of claim 1, wherein the software instructions further compute divergence indices between this instance and other federated instances, compare computed divergence against autonomy envelopes, and apply corrective actions when divergence exceeds thresholds.

10. The computer system of claim 1, wherein updating manifold curvature comprises deepening attractor basins for frequently accessed regions, maintaining smooth transitions to prevent geometric discontinuities, and propagating curvature changes to ensure global consistency.

11. A computer-implemented method for federated thought caching in a persistent cognitive machine, comprising the steps of:
maintaining a latent manifold as a geometric substrate for cognitive operations, wherein local curvature reflects semantic density;
implementing a distributed thought cache comprising a local thought cache storing instance-specific thought trajectories and a shared cache space containing generalized thoughts for cross-instance sharing;
encoding inputs into latent query trajectories and determining cache hits based on geometric similarity to cached thoughts;
upon cache hits, retrieving and adapting cached thought trajectories to current context;
upon cache misses, synthesizing new compressed thoughts for caching;
applying privacy-preserving geometric transformations to thoughts selected for federation;
synchronizing transformed thoughts across distributed instances through federated interfaces;
aligning received thoughts from the shared cache to local manifold geometry through geodesic registration; and
managing cached thoughts through activation energy monitoring, consolidating low-energy thoughts into active bundles and updating manifold curvature to reflect usage patterns.

12. The method of claim 11, wherein the latent manifold comprises a hierarchical structure with a fast manifold representing event-level cognition, a mesoscale manifold representing decision-level cognition, and a foundational manifold representing identity and long-term objectives.

13. The method of claim 12, further comprising implementing upward abstraction mappings as Riemannian submersions preserving local geodesic structure and downward constraint injection mappings as immersions defining allowable submanifolds.

14. The method of claim 11, wherein determining cache hits comprises computing geodesic distance, curvature pattern matching, basin proximity, and trajectory compatibility scores between query trajectories and cached thoughts.

15. The method of claim 11, wherein the privacy-preserving geometric transformations comprise curvature-preserving deformations maintaining sectional curvature within tolerance, semantic generalization mapping specific entities to categorical abstractions, and type-restricted masking removing sensitive information while preserving trajectory continuity.

16. The method of claim 11, wherein geodesic registration comprises solving an optimization problem that minimizes distortion between received thoughts and local manifold structure while preserving semantic structure through geometric transformations.

17. The method of claim 11, wherein managing cached thoughts comprises applying thermodynamic decay where activation energy decreases over time for unused thoughts and increases for successfully retrieved thoughts.

18. The method of claim 11, wherein consolidating low-energy thoughts comprises geometric merging operations including curvature-weighted averaging, trajectory folding compressing similar paths, and bundle expansion incorporating thoughts into existing structures.

19. The method of claim 11, further comprising computing divergence indices between this instance and other federated instances, comparing computed divergence against autonomy envelopes, and applying corrective actions when divergence exceeds thresholds.

20. The method of claim 11, wherein updating manifold curvature comprises deepening attractor basins for frequently accessed regions, maintaining smooth transitions to prevent geometric discontinuities, and propagating curvature changes to ensure global consistency.
